(19) United States
(12) Patent Application Publication
(10) Pub. No.: US 2011/0178881 A1
(43) Pub. Date: Jul. 21, 2011

(54) COLLABORATIVE MATCH MAKING SYSTEM AND METHOD WITH A PER-PROFILE CONFIDENTIAL INFORMATION PURCHASE OPTION

(75) Inventor: PULLETIKURTY RAVI KUMAR PULLETIKURTY, VISAKHAPATNAM (IN)

(73) Assignee: PULLETIKURTY RAVI KUMAR PULLETIKURTY, VISAKHAPATNAM (IN)

(21) Appl. No.: 13/007,607

(22) Filed: Jan. 15, 2011

(30) Foreign Application Priority Data
Jan. 18, 2010 (IN) 110/CHE/2010

(51) Int. Cl. G06Q 30/00

(52) U.S. Cl. 705/14.73; 705/26.1; 705/26.3; 705/14.4

(57) ABSTRACT

A system and method to collaborate and/or consolidate and display the paid, active profiles data (including optionally related social data from social system[s]) but barring confidential information of paid, active profiles, of one or more participating match making brokers to local and remote users/customers soliciting match making brokerage service. Moreover, the system comprises one or more servers (103) connected to a network (102), which processes the business logic, and one of more data stores (104) for storing persistent data related to match making profiles and related information. The method comprises the steps where in an unregistered/registered end user (101) looking for match making brokerage service uses the above defined system to view one or more prospective paid, active profiles data and optionally purchase their confidential information without having to mandatorily enroll in a paid membership that provides match making brokerage service for a specific period of time.

### CROSS-REFERENCE TO RELATED APPLICATIONS

This application claims the priority benefit of Indian provisional patent application Ser. No. 110/CHE/2010, filed Jan. 18, 2010, the contents of which is hereby incorporated by reference.

### FIELD OF THE INVENTION

The invention pertains generally to the field of brokerage services and, in more particular, to system and method for a match making brokerage service and by extension to other brokerage services which considerably improves service to users soliciting brokerage service.

### BACKGROUND OF THE INVENTION

The world at present is more electronically connected than ever before. Newer systems and methods have evolved to connect people using network mediums such as Internet, cellular networks, radio, Wi-Fi, Blue Tooth, Cable Networks, Telephone Network. Users have started to increasingly use electronic communicating devices such as Smart Phones, Smart Televisions, IPads, Laptops, Desktops, Tablets to meet their content needs and communication needs. As the world became more and more connected and globalised, people have felt the need for targeted data systems to cater to their specific information needs. The same is also true to the domain of match making brokerage services.

Many data consolidation/collaboration broker systems such as for e.g. Bharatmatrimony.com, Match.com, Shaadi.com, AmericanSingles.com, SimplyMarry.com, EHarmony.com, Mypartner.com, etc have come up to meet these needs. These match making brokers/systems allow people seeking match making brokerage service to post their profile in their system and take a paid membership to find their romantic partner on their system. The paid membership service is valid for a specific period of time after which the user has to renew to continue to use the paid features.

One such paid feature is providing the means for the paid member to contact the other members who match his/her partner preference criteria. The way this contacting is enabled is done differently by different match making brokers. Some allow the paid member to view the confidential information (contact phone number, contact email, contact address, photo, etc.) of another member who match his/her partner preference criteria while others allow these two members to meet physically in their office or talk over phone without the members knowing each other's phone numbers. And lot others allow their paid members to communicate directly in their system. Since the task of finding a partner could take quite a time, people end up renewing their membership again and again whenever their time-bound membership has expired. They do it just to have this ‘means to contact prospective partner(s)’ paid feature.

Also many match making brokers (Bharatmatrimony.com, Shaadi.com, SimplyMarry.com) restrict the number of profiles' contact information that a paid member can view, esp., if the paid member wants to contact a profile member who has not accepted his/her invitation or is not in his/her network in the broker system. If the paid member having a 3 months membership package and ability to view 25 such profiles' contact information has used his/her entire quota in 2 months, he/she has to purchase additional quota to view more such profiles contact information in the remaining membership period.

Most profiles on these broker systems contain obsolete profile content. The profile information of users is only as good as the last update done by the user to the profile on the broker system. So if a member, seeing some interesting profile information, contacts a prospective partner using his/her allocated ‘profile contact information’ quota and finds from the prospective partner that the information he/she saw is obsolete and no longer relevant, it will lead to dissatisfaction with the broker service as he/she is not only disappointed with false expectations but has also lost one count in the allocated quota.

Most people needing the match making services take the time-bound paid membership in one or more of such broker systems with an intent of finding their partner soon. And when they don't find their partner within the stipulated time of their paid membership and if they don't have enough money to take these paid membership(s) again, they feel frustrated with the service of these brokers.

Some brokers such as Freemarriage.com have attempted to remove this ‘time-bound membership’ problem by offering people their match making brokerage as a free service. However they suffered from drawbacks such as lack of credibility, non-serious nature of free profile members, inability of their broker systems to distinguish serious profiles from non-serious or already committed profiles, etc.

Most people needing the match making services would ideally desire to have the ability to pay small fee for individual prospective partner's confidential information disclosure and not get into a costly, time-bound paid membership or its restricted quotas. They would ideally desire to view several match making brokers' profiles information in a single system and have the ability to contact any of prospective partners belonging to these brokers. They would ideally desire to view the real-time/near real-time content for partner profiles and not fear that partner profiles content may be obsolete.

To sum up, the biggest disadvantages with most existing major match making systems are
(i) They are disconnected, independent data stores containing profiles information.
(ii) They offer time-bound membership schemes;
(iii) They show static profile information of users.

Therefore, it would be beneficial to provide a improved system and method for collaboration, which for example can overcome the illustrative drawbacks of existing methods and systems mentioned or provide new functionality to users.

### SUMMARY OF THE INVENTION

In accordance with the principles of the present invention, a system and method to collaborate and/or consolidate and display the paid, active profiles data of numerous match making brokers and provide local and remote customers seeking confidential information of these prospective profile(s) with a per-profile ‘confidential information’ purchase option.

Additionally, the system and method uses a brokerage/commission selling model where in the participating match making brokers that allow display of their paid, active profiles content on the system get an agreed-upon portion of the purchase money (606) and remaining amount of the purchase money belongs to the owner(s) of the system as maintenance fee for providing the service (609).

As disclosed herein the invention adopts an improved brokerage mechanism that leverages the following important elements to provide value-added services to end users seeking brokerage service.
(i) Connected systems technologies, social mashup technologies, and other related technologies;
(ii) Brokers data, users data, social networking data and other related data.

The present invention establishes a collaborative trust platform which provides numerous technical advantages. Various aspects of the present invention may have all, some or none of these advantages. Some of such technical advantages are
(i) Capability of providing a collaboration match making brokerage platform that displays profile information of numerous match making brokers on a single system;
(ii) Provision of allowing people seeking confidential information of the prospective partner profile(s) to purchase those individual information without getting into a time-bound membership schemes.
(iii) Provision of showing the consenting members' social data in profile alongside their static profile data, taking into account the fact that most members communicate on everyday basis on social applications in Internet, mobile devices, etc., and share ‘content-of-interest’ which when displayed on their profile alongside static data would arouse interest in prospective partners who view that info.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention is best understood from the detailed description which follows, taken in conjunction with the accompanying invention, in which:

FIG. 1 is a block diagram of an illustrative collaborative system according to an embodiment of the invention.

FIG. 2 illustrates the scope/domain of various end user categories and end user types in the Match Making Brokers Data Consolidation/Collaboration Portal System (or MMBDC Portal System) according to an embodiment of the invention.

FIG. 3 illustrates the relationship between various end user types and maps some of the system features/‘privileges allowed’ to different end user types according to an embodiment of the invention.

FIG. 4 illustrates different types of system users accessing the system using different communicating devices that use different underlying networks according to an embodiment of the invention.

FIG. 5 illustrates the various modules of the system according to an embodiment of the invention.

FIG. 6 illustrates various functions for different types of system users in the MMBDC Portal system according to an embodiment of the invention.

FIG. 7 illustrates the system's architecture with data flow across system for various scenarios according to an embodiment of the invention.

FIG. 8 illustrates the system's Shared Events System Calendar according to an embodiment of the invention.

FIG. 9 is an illustration of user interface that enables the user to free revelation of Confidential Information of some Paid Active Profiles (or PAPs) on MMBDC Portal System for Promotional purposes according to an embodiment of the invention.

FIG. 10 (a) to FIG. 10 (d) is an illustration of user interface that enables the user to ‘View Profile’ system screens related to displaying data from social systems. The system screens explain a use case scenario according to an embodiment of the invention.

FIG. 10 (a) is an illustration of user interface that enables the user to ‘View Profile’ system screen that the Paid Active Profile (PAP) member sees after he/she logs into system and clicks on ‘View My Profile’ button, according to an embodiment of the invention.

FIG. 10 (b) is an illustration of user interface that enables the user to ‘View Profile’ system screen where the PAP member selects Facebook and LinkedIn panels according to an embodiment of the invention.

FIG. 10 (c) is an illustration of user interface that enables the user to ‘View Profile’ system screen where the PAP member manages privacy settings on his/her social info in ‘Settings’ tab of social panel(s) on this screen according to an embodiment of the invention.

FIG. 10 (d) is an illustration of user interface that enables the user to ‘View Profile’ system screen where the PAP member sees his/her Facebook's social info in the ‘View info (as seen by you)’ tab of Facebook social panel on this screen according to an embodiment of the invention.

FIG. 11 is an illustration of user interface that enables the user to Privacy system screen where the PAP member sets his/her system-level privacy settings and buyer filters according to an embodiment of the invention.

### DEFINITIONS

It is to be understood that this invention is not limited to particular general terminology described herein and as such may vary. It is also understood that the terminology used herein is for the purpose of describing particular embodiments only, and is not intended to limit the scope of the present invention, which will be limited only by the appended claims.

As used in herein and in the appended claims, the singular forms “a”, “an”, and “the” include plural reference unless the context clearly indicate otherwise.

Unless defined otherwise, all technical and scientific terms used herein have the same meaning as commonly understood to one of the ordinary skill in the art to which the invention belongs. Although any methods and systems similar or equivalent to those described herein can be used in practice or testing of the invention, the preferred methods, systems are now described.

The term “Bulk Profiles Confidential Information purchase option (a.k.a. BPCI purchase option)” refers to—Option to purchase some or all of confidential details include, but are not limited to, name, contact addresses, photographs, contact residence phone numbers, contact cell phone numbers, contact email addresses, referrals names, referrals contact addresses, etc.,] of more than one prospective romantic partner. Bulk profiles confidential information can be purchased by adding more than 1 item to the MMBDC Portal System shopping cart.

The term “Confidential Information” refers to—Saleable data that is in possession with the broker and which is withheld by the broker from displaying to the interested party and revealed to the interested party upon purchase of that information. Example: Some or all of the details [name, contact address(s), photograph(s), contact residence phone number(s), contact cell phone number(s), contact email address(s), referrals names, referrals contact address(s), etc.,] of a prospective profile member (i.e., prospective romantic partner) that is withheld by the MMBDC Portal System or the Match Making Brokers from displaying to the end user and revealed to end user upon purchase of that information.

The term “Duplicate Paid Active Profiles” refers to—If more than one participating Match Making Broker has uploaded/shared the same Paid Active Profile on the MMBDC Portal System, then all such repeated Paid Active Profiles are considered duplicate profiles.

The term “‘Favorite Profiles’ listing” refers to—The registered MMBDC member, in his/her browsing session on MMBDC Portal System, can save prospective profiles for viewing/buying in his/her future browsing session(s). This list of favorite profiles thus help the registered MMBDC member avoid unnecessary searches of profiles in the current or future browsing session(s) to find a previously seen profile.

The term “Mashup” refers to—An application or screen that uses or combines data or functionality from two or more external sources to create a new service.

The term “Match Making Broker (MMB)” refers to—A person, company, organization or an institute that arranges or tries to arrange romantic partners for its customers who solicit them for match making brokerage service. The broker may or may not charge a fee to make this arrangement. For e.g. Voluntary, Not-for-profit, Community-based MMBs sometimes do not charge a fee for providing this service.

The term “MMBDC paid members” refers to—MMBDC Portal System end users who have one or more types of MMBDC ‘paid memberships’.

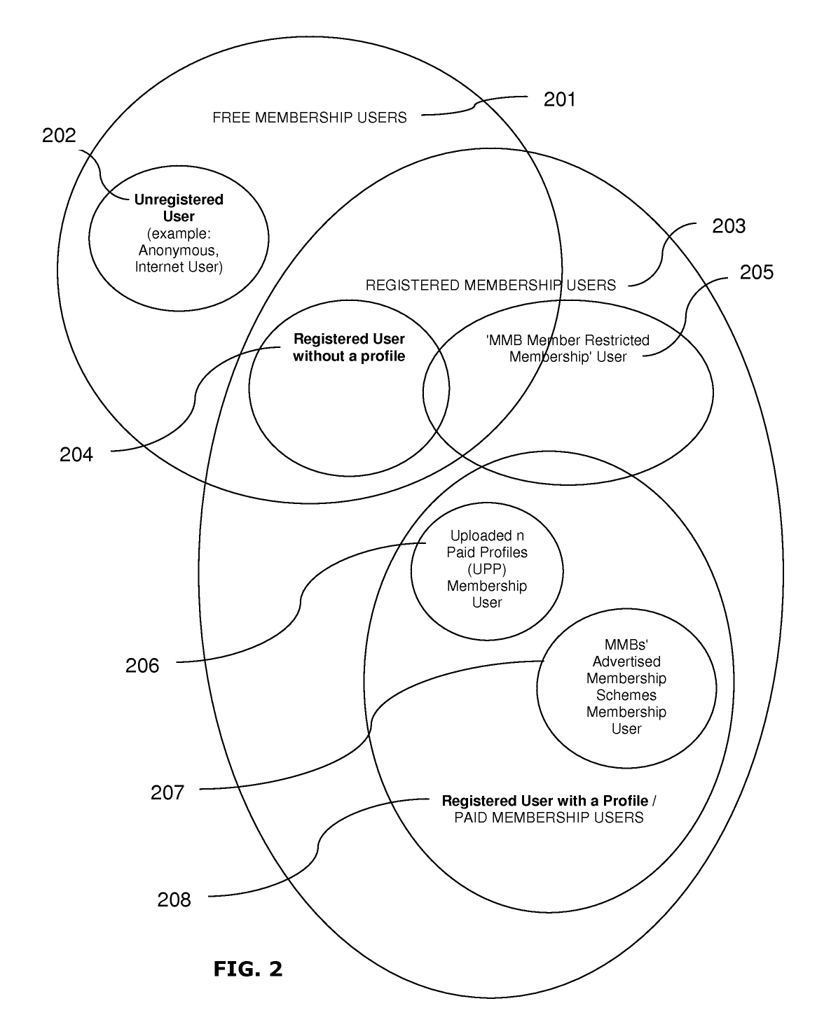

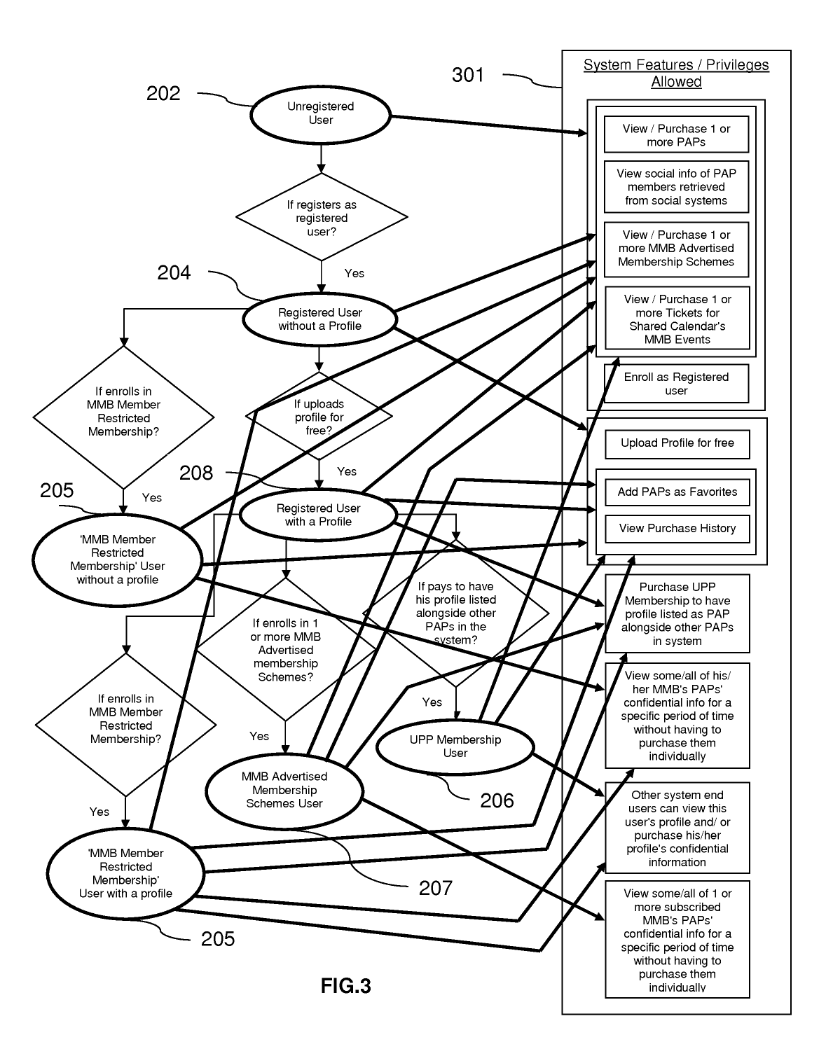

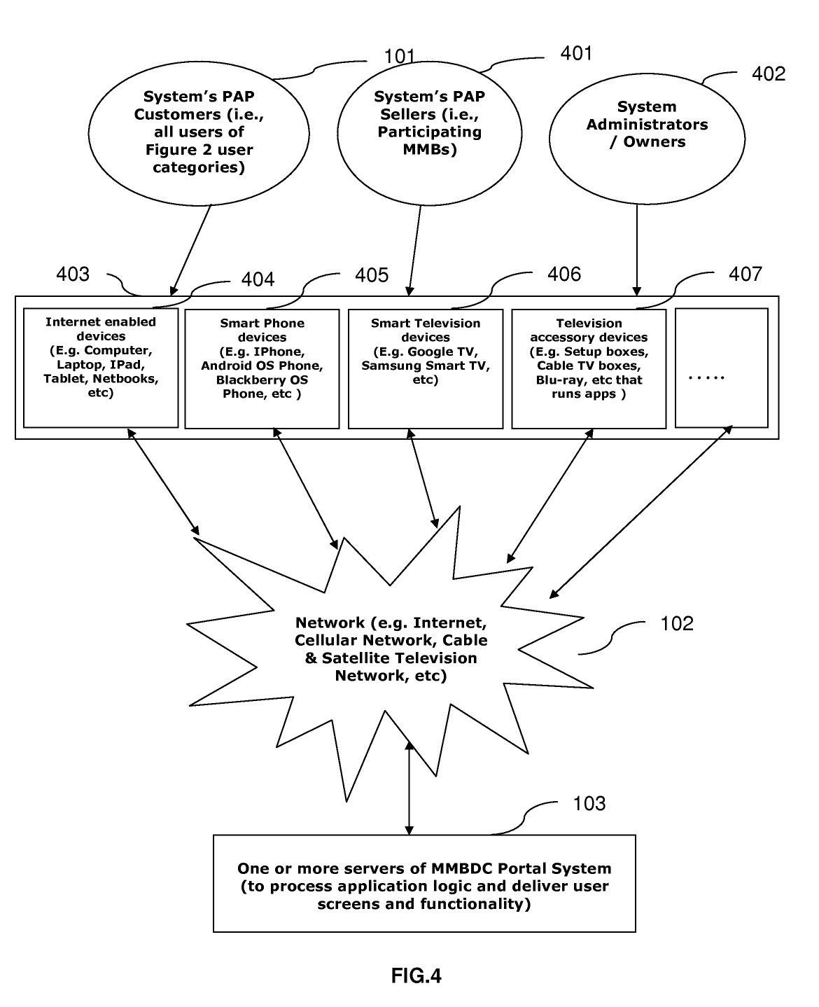

The term “MMBDC Portal System User” refers to—The local or remote user who browses/navigates the MMBDC Portal System. The system users types include but not limited to:
(i) End users (i.e., users belonging to any of the user categories or types shown in FIG. 2)—They can be loosely defined as PAP members/system customers.
(ii) Business users (i.e., Participating MMBs)—They can be loosely defined as PAP sellers
(iii) Admin users (i.e., MMBDC Portal System Administrators/MMBDC Portal System Owners).

The term “MMBDC Profile Data Life-cycle' process” refers to—Changes that happen to Paid Active Profile's data from its inception on system till its retirement from MMBDC Portal System. These changes can be initiated by the PAP member or by his/her referral or by the PAP member's MMB or by the MMBDC Portal System administrator.

The term “Paid Active Profile (PAP)” refers to—The profile of a person present in total data store of MMBDC Portal System where the profile's ‘paid-membership status’ is ‘Paid’ and profile's ‘seeking status’ is ‘Active’ and wherein the person has consented directly on MMBDC Portal System or indirectly through his/her Participating Match Making Broker or through his/her referral, to have his/her Confidential Information sold on MMBDC Portal System or on other platforms owned by MMBDC Portal System owners for the purpose of match matching. ‘Paid’ value for profile's ‘paid-membership status’ means the money was paid by customer or by his/her referral to either the participating match making broker or to the MMBDC Portal System for obtaining match making brokerage service for a specific period of time and where the current date is within this specified period of time. ‘Active’ value for profile's ‘seeking status’ means the profile person is currently seeking a romantic partner. For those profiles where the participating match making brokers provided the profile members with paid memberships that doesn't expire after a specified period of time (say, a one-time membership fee for the life of the profile member), the MMBDC Portal System owner(s) would specify a fixed period of time from the start date of the paid membership of these profiles. If for these profiles, the current date falls within their allocated, fixed period of time and if their ‘seeking status’ is ‘Active’, then these profiles are considered Paid Active Profiles (PAPs).

The term “Paid Active Profile member” refers to—Member (or person) described in the Paid Active Profile.

The term “Participating Match making Broker” refers to—Match making broker who is participating in the MMBDC Portal System and Method.

The term “Per-Profile Confidential Information purchase option (or PPCI purchase option)” refers to—Option to purchase some or all of confidential details [name, contact addresses, photographs, contact residence phone numbers, contact cell phone numbers, contact email addresses, referrals names, referrals contact addresses, etc.,] of one prospective romantic partner. It is also simply referred as ‘per-profile purchase option’.

The term “Per-Data Item Confidential Information purchase option” refers to—Option to purchase some or all of confidential details of one prospective data item.

The term “Profile Data” refers to—Confidential information and public information of prospective romantic partner specified in the profile. This information is provided to MMBDC Portal System or provided to its participating match making broker during the registration of profile paid membership.

The term “Social Data” refers to—Social information of prospective romantic partner specified in the profile. The social info includes but not limited to profile details (name, age, height, etc.), social networking info (photos shared with others, friends list, messages, videos, events, recent user activities, status, family, relationships, etc.), employment details (employer name, salary, past employers, colleagues list, etc.), etc., of prospective romantic partner. This information is provided to MMBDC Portal System by prospective romantic partner though his/her explicit consent to MMBDC Portal System to fetch this social info from the social system/match making system and to display on MMBDC Portal System.

The term “Social System” refers to—Any website or electronic program (running on any communicating device) that allows two or more people to connect and collaborate and/or communicate. Examples of social systems include but not limited to Facebook, LinkedIn, Orkut, Twitter, hi5, MySpace, Yahoo, match making/dating sites such as Match.com, eHarmony.com, Bharatmatrimony.com, Shaadi.com, Zoosk.com, Loopt, etc. Participating social system/participating match making system is a social system/match making system that is participating in the MMBDC Portal System and Method.

The term “Seeking Status” refers to—A profile's attribute (or say, field in profile data) that describes whether the profile person is seeking a romantic partner or not. A value of ‘Active’ means that the profile person is currently seeking a romantic partner. A value of ‘Inactive’ means that the profile person is currently not seeking a romantic partner. A value of ‘Closed’ means that the profile person is no longer interested in seeking a romantic partner.

The term “Total data store of MMBDC Portal System” refers to—MMBDC Portal System's consolidated/collaborated data store which includes but not limited to Participating MMBs data stores, Uploaded n Paid Profiles (UPP) data store, and “Participating MMBs' Advertised Membership Schemes Enrolled Members Profiles” data stores.

The term “System Customer” refers to—A local or remote end user who shops on the System.

The term “System End User” refers to—A local or remote end user who browses/navigates the System.

### Definitions Related to Extensibility of ‘MMBDC Portal System and Method’:

The term “Broker” refers to—A party that mediates between a buyer and a seller. A party can be a person, company, organization or an institute. The party may or may not charge a fee to provide this service. If it charges a fee, it can charge the buyer or the seller or both.

The term “Rental broker” refers to—A broker that acts as an intermediary between providers and customers of rental accommodation and attempts to find providers who wish to provide rental accommodation and purchasers who wish to rent those accommodations.

The term “Employment broker” refers to—A broker that acts as an intermediary between sellers and buyers of labor/human resources.

The term “Advisory brokers (in various knowledge areas/business domains)” refers to—Brokers that provide advice to customers seeking advice in specific knowledge area/business domain. These brokers loop in one or more Subject Matter Experts (SMEs) in the specific knowledge area/business domain to answer questions of customers. If the question is previously answered for another customer, they would provide the same answer to all customers asking same question. They may or may not charge a fee to provide this service. Examples of such knowledge areas/business domains: Law (Civil, Criminal, Immigration, Patent, etc.), Medical, Computer Science, Finance, etc.

The term “List broker” refers to—A broker that acts as an agent for those who wish to conduct direct marketing campaigns via direct mail, email or telemarketing. The list brokers act as “go-betweens” matching ‘list owners’ to ‘list seekers’ (i.e., those who wish to buy or rent lists), receiving a commission from the list owners. Additionally, many list brokers supply a client with information, price guidelines and other consultation on the purchasing of lists and data.

The term “Real estate broker” refers to—A broker that acts as an intermediary between sellers and buyers of real estate (i.e., land along with improvements to the land, such as buildings, fences, wells and other site improvements that are fixed in location—immovable) and attempts to find sellers who wish to sell and buyers who wish to buy.

The term “Investment broker” refers to—A broker that brings together buyers and sellers of investments. In finance, investment is the commitment of funds by buying securities or other monetary or paper (financial) assets in the money markets or capital markets, or in fairly liquid real assets, such as gold, real estate, or collectibles. Buyers and sellers instruct their investment brokers to find suitable sellers and buyers respectively and execute trades on their behalf and in return they pay their broker a commission. The investment brokers need a license to operate. They charge a commission from buyers and sellers on trades that they execute on such instructions from these buyers and sellers._{—}

The term “Sponsorship broker” refers to—A broker that acts as an intermediary between event or entity owners and sponsors (individuals or agencies) that provide funding for the event or entity. The sponsorship brokers procure sponsorship funding for their clients. The sponsors derive benefit from the associations created for their company's brand(s) or image as a result of the sponsorship.

The term “Business broker” refers to—A broker that acts as an intermediary between sellers and buyers of small businesses. Business brokers assist buyers and sellers of privately held small business in the buying and selling process. They typically estimate the value of the business; advertise it for sale without disclosing its identity; handle the initial potential buyer interviews, discussions, and negotiations with prospective buyers; facilitate the progress of the due diligence investigation and generally assist with the business sale. Agency relationships in business ownership transactions involve the representation by a business broker (on behalf of a brokerage company) of the selling principal, whether that person is a buyer or a seller. The principal broker (and his/her agents) then become the agent/s of the principal, who is the broker's client. The other party in the transaction, who does not have an agency relationship with the broker, is the broker's customer.

The term “Joint venture broker” refers to—Skilled networkers that can find key people/businesses in different niches and connect them to other people/businesses in the same niche in order to share one businesses products/services. They connect business joint venture partners together for profit making projects. Often a joint venture broker will be hired by a business that has either a product, service, or a customer base that could be better monetized. The product/service owner will be seeking partners who have a customer base that is targeted to their product/service. Like-wise the person/business with a customer base (often ezine/newsletter publishers or high traffic webmasters) will be seeking products and services related to their customers' interests so they can market them to their customers.

### DETAILED DESCRIPTION OF THE INVENTION

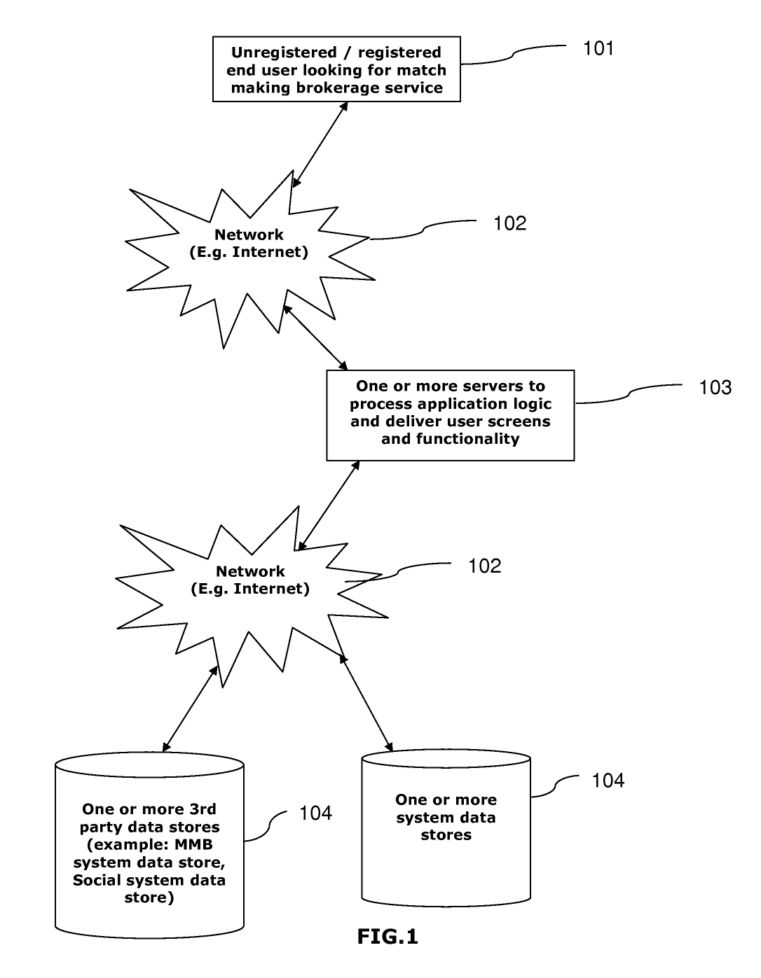

FIG. 1 is a high level view of a system which comprises of one or more servers (103) connected to a network (102), which processes the business logic, including processing requests for profiles information, matching profiles with requestor's profile, and so on. The server(s) connect with one of more data stores (104) for storing persistent data related to match making profiles and related information.

The invention can be construed as a System and Method, specifically a ‘Match Making Brokers Data Consolidation/Collaboration (MMBDC) Portal System and Method’ that collaborates and/or consolidates and displays Paid Active Profiles (PAPs) data (including optionally social data of profile members from social system[s] for consenting profile members) but barring confidential information of PAPs, of one or more Participating Match Making Brokers (MMBs) to local and remote users/customers soliciting match making brokerage service who can then view one or more prospective PAPs data and optionally purchase their confidential information without having to mandatorily enroll in a paid membership that provides match making brokerage service for a specific period of time (example: 1 month membership, 3 months membership, etc.).

AS described above, the system can be better illustrated using the below two examples.

Example 1 provides an exemplary illustration of the present invention as a system using Internet as network and displaying match making profiles information to a remote web user in a web browser wherein the profiles information is retrieved from system's remote data stores as well as from participating MMBs' remote data stores and social systems' remote data stores.

Example 2 is yet another exemplary illustration of the present invention wherein a system using cellular network (example: GSM/GPRS/EDGE/3G/4G/CDMA/etc.) displays match making profiles information to a remote smart phone user in the smart phone screen wherein the profiles information is retrieved from system's remote data stores as well as from participating MMBs' remote data stores and social systems' remote data stores.

FIG. 2 illustrates the scope/domain of various end user categories and end user types in the MMBDC Portal System, wherein the Free membership users include Unregistered users, Registered users without a profile, and some of ‘MMB Member Restricted Membership’ users. Further the Registered membership users include Registered users without a profile, ‘MMB Member Restricted Membership’ users, UUP Membership users and MMBs' Advertised Membership Schemes Membership users. Also the Registered users with a profile/Paid Membership users include UUP Membership users, MMBs' Advertised Membership Schemes Membership users and some of ‘MMB Member Restricted Membership’ users. In addition to the above, some of the ‘MMB Member Restricted Membership’ users can be Registered users without a profile, based on pre-set agreements between MMB(s), its members and the system owners.

FIG. 3 shows the relationship between various end user types and maps some of the system features/‘privileges allowed’ to different end user types.

FIG. 4 shows the different types of system users accessing the system using different communicating devices that use different underlying networks, wherein the different system users (End users, Participating MMBs, System Admins/Owners) can use a internet-connected device/smart phone/smart TV/TV accessory device to access the system and perform their tasks on the system. In case of devices categories such as smart phone, smart TV and TV accessory devices, the system can run as app/customized site/etc., on these devices and provide the needful system functionality to the system user. In case of internet enabled devices, the system can run as web application/web service/etc., and provide the needful system functionality to the system user.

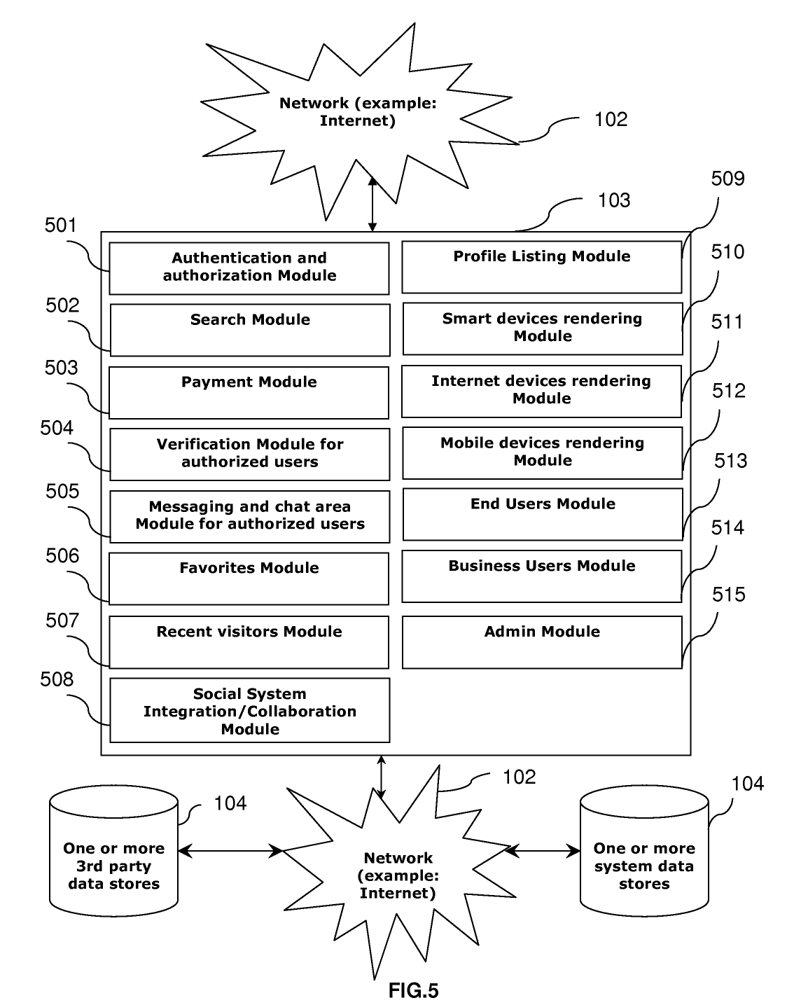

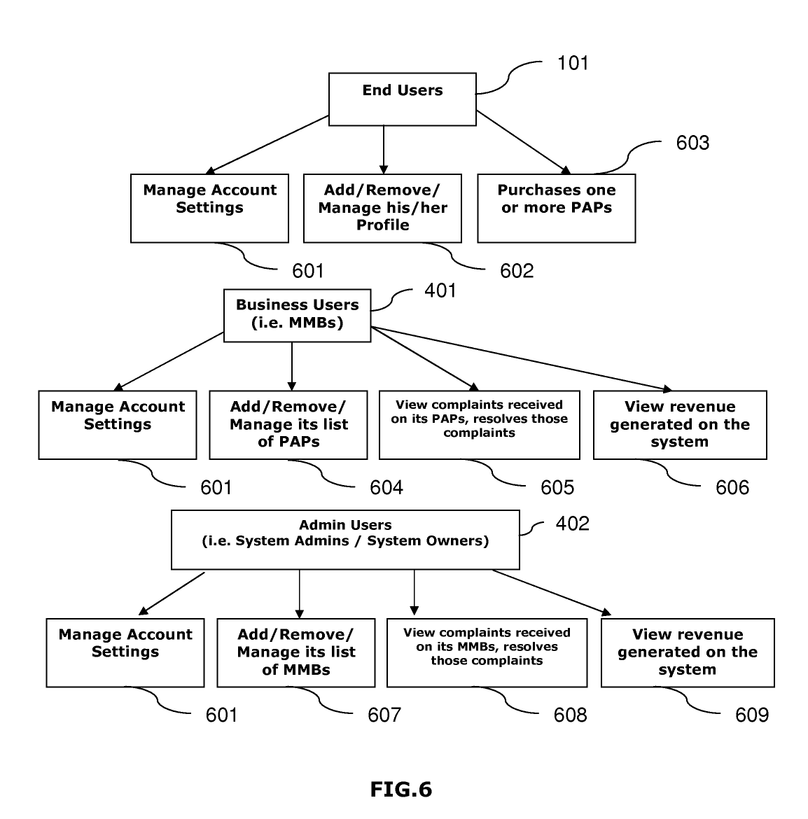

FIG. 5 shows the embodiment of the system with various modules, wherein the system comprises modules of functionality in server-side and/or client-side. These modules include but not limited to:
(i) ‘Authentication and authorization Module’ which allows authentication and authorization of different types of system users and their sub-types (if any) to log into the system and access various features of the system;
(ii) ‘Search Module’ which allows system users to search various Paid Active Profiles (PAPs) based on user input criteria. The search options include but not limited to (a) search profile by PAP id (b) search profiles by MMB id (c) search profile by basic, important profile parameters [example: gender, seeking status, age range, height range, marital status, mother tongue, etc.,] (d) search profile by advanced profile parameters [example: physical status—normal/disabled, location details, education details, employment details, horoscope details, habits, etc.,] (e) search profiles based on profile keywords (f) quick search, etc.,
(iii) ‘Payment Module’ which allows end users to purchase Paid Active Profiles (PAPs) and membership schemes using custom payment system or through a variety of participating 3rd party online payment service providers (example: PayPal, Google Checkout, ccAvenue, Beanstream, Moneris, Internet Secure, iCongo, PsiGate etc.). This module provides online payment capabilities to end users such as online credit card/debit card payment, online check payment, etc., It also displays procedures for offline payment which include but not limited to postal check payment, money order payment, phone payment, payment to affiliate local agencies, etc;
(iv) ‘Verification Module for Authorized users’ which allows verification of confidential information for authorized users;
(v) ‘Messaging and chat area Module for authorized users’ which allows authorized end users to communicate with each other by sending direct messages to other end users inboxes or by chatting with them online on instant messenger;
(vi) ‘Favorites Module’ which allows authorized end users to save Paid Active Profiles (PAPs) of prospective members to Favorites section so that these PAPs can be later easily accessed in next login sessions;
(vii) ‘Recent visitors Module’ which allows authorized end users to view the recent visitors to their PAPs as well as to other PAPs;
(viii) ‘Social System Integration/Collaboration Module’ which allows integration/collaboration with various social systems;
(ix) ‘Profile Listing Module’ which allows display of profiles that are both ‘paid’ and ‘active’, It also takes into consideration the privacy settings set by PAP members while displaying the PAPs;
(x) ‘Smart devices rendering Module’ which comprises functionality related to rendering the system on smart devices such as Television accessory devices;
(xi) ‘Internet devices rendering Module’ which comprises functionality related to rendering the system on Internet devices;
(xii) ‘Mobile devices rendering Module’ which comprises functionality related to rendering the system on mobile devices;
(xiii) ‘End Users Module’ which comprises screens and functionality of system related to end users, as partially shown in FIG. 6;
(xiv) ‘Business Users Module’ which comprises screens and functionality of system related to business users, as partially shown in FIG. 6;
(xv) ‘Admin Module’ which comprises screens and functionality of system related to admin users, as partially shown in FIG. 6.

FIG. 6 shows some of the functions of different types of system users in the MMBDC Portal system. These functional modules include but not limited to:
(i) End Users Module includes key functions done by end users which are not limited to—view PAPs, purchase 1 or more PAPs, manage account settings (example: privacy settings, change password, etc.), add/edit/remove profile, view favorite PAPs, view payment history, etc., as shown in FIG. 3.
(ii) Business Users Module includes key functions done by business users which are not limited to—manage account settings, add/edit/remove its list of PAPs shared on system, view and resolve complaints on its PAPs, view revenue generated on the system against each of its PAP shared on system, view overall revenue generated on the system against its list of PAPs, etc.,
(iii) Admin Users Module includes key functions done by admin users which are not limited to—manage account settings, add/edit/remove its list of participating MMBs, view and resolve complaints on its MMBs, view revenue generated on the system against each of its participating MMB, view overall revenue generated on the system against its list of participating MMBs, etc.

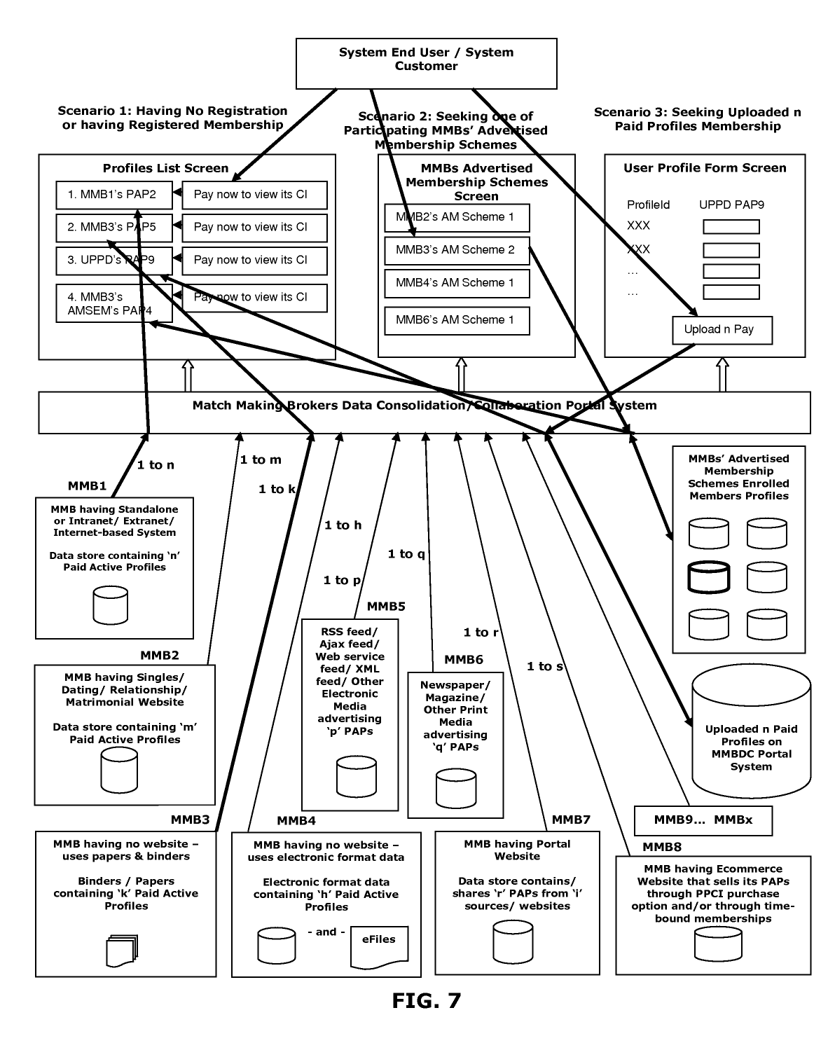

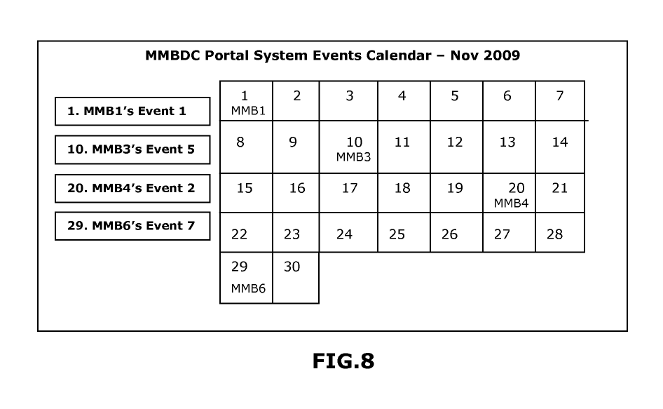

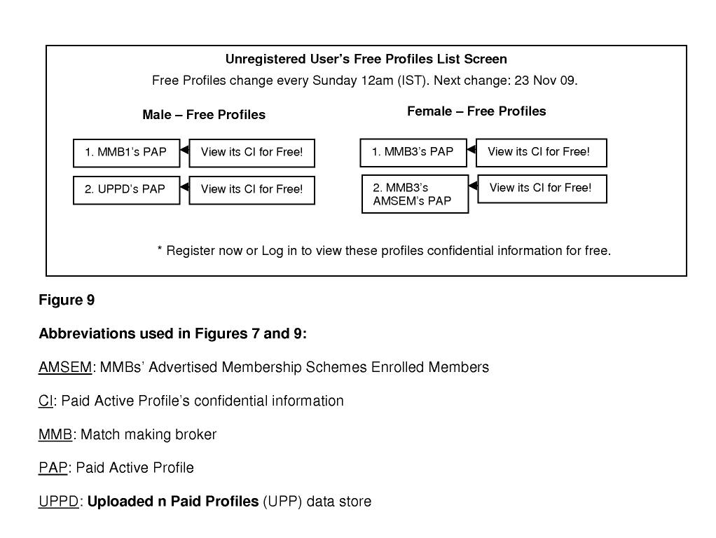

FIG. 7 shows the system's architecture with data flow across system for various scenarios, As shown in FIG. 7, three scenarios related to system end user are depicted in this diagram, wherein scenario 1 illustrates end user having no registration or having registered membership views the profile list screen which displays PAPs of various MMBs, PAPs from Uploaded n Paid Profiles data stores, PAPs of various MMBs from MMBs' Advertised Membership Schemes Enrolled Members data stores, PAPs of various MMBs from ‘MMB Member Restricted Membership’ data stores (not shown), etc., The end user finds one or more PAPs from this list as prospective match(s) and purchases its/their confidential information; wherein scenario 2 illustrates end user having no registration or having registered membership views the MMBs Advertised Membership Schemes screen which displays list of Advertised Membership Schemes of various MMBs. The end user finds one or more schemes from this list as interesting and purchases its/their membership; wherein scenario 3 illustrates end user having no registration or having registered membership creates a profile on the system and pays for having it listed alongside other PAPs on the system. The end user thus becomes a UPP membership member. Further the FIG. 7 shows various types of MMBs that can participate in the system. It also shows some of the other data stores of the system. Not shown in the FIG. 7 are 3rd party social systems data stores, ‘MMB Member Restricted Membership’ data stores of various MMBs, etc., The ‘1-n’ relationship shown for participating MMB1 means that MMB1 has total of ‘n’ PAPs in its data store and it can share/contribute minimum of 1 PAP up to a maximum of n PAPs from its data store to the system.

FIG. 8 shows the system's Shared Events System Calendar, where in the end user views the shared events calendar to see various events of participating MMBs. He/she clicks on the event to view its details and optionally purchase the event tickets. These events can be get-together parties arranged for its PAP members and non-members by MMBs, speed dating events conducted for its PAP members and non-members by MMBs, etc.

FIG. 9 shows one example of Free Revelation of PAPs Confidential Information on MMBDC Portal System for Promotional purposes, wherein the end user having no registration views a Free Profiles list screen where a specific number of PAPs of both genders are shown for a specified time period after which the screen is refreshed with new PAPs. The confidential information of the PAPs displayed on this screen will be revealed for free to requesting end users. Based on privacy settings, only PAPs of those members who have consented to having their PAP's confidential information shown for free to end users will be shown in this Free Profiles list screen.

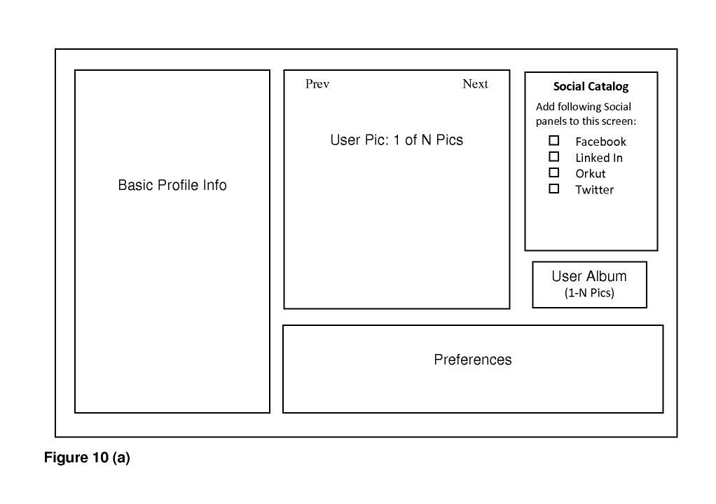

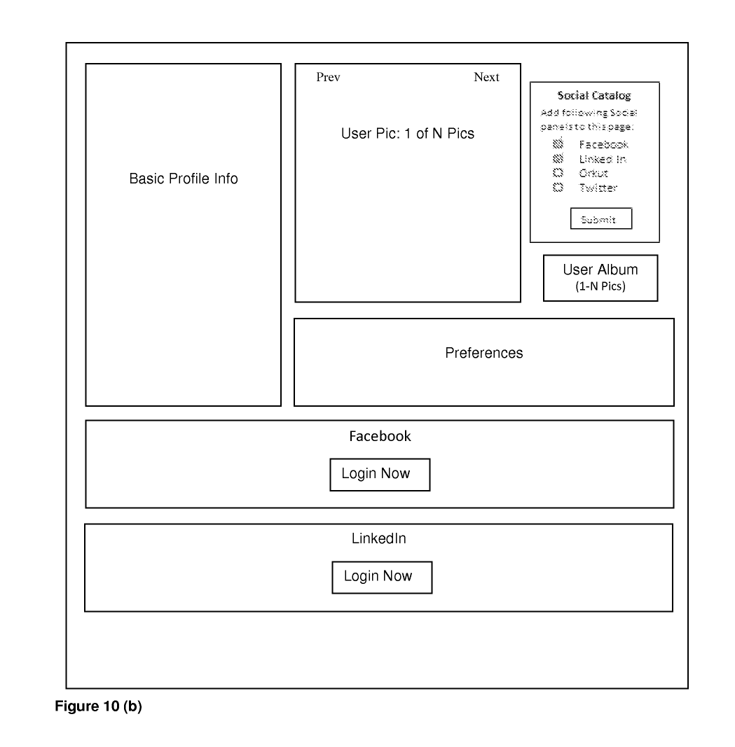

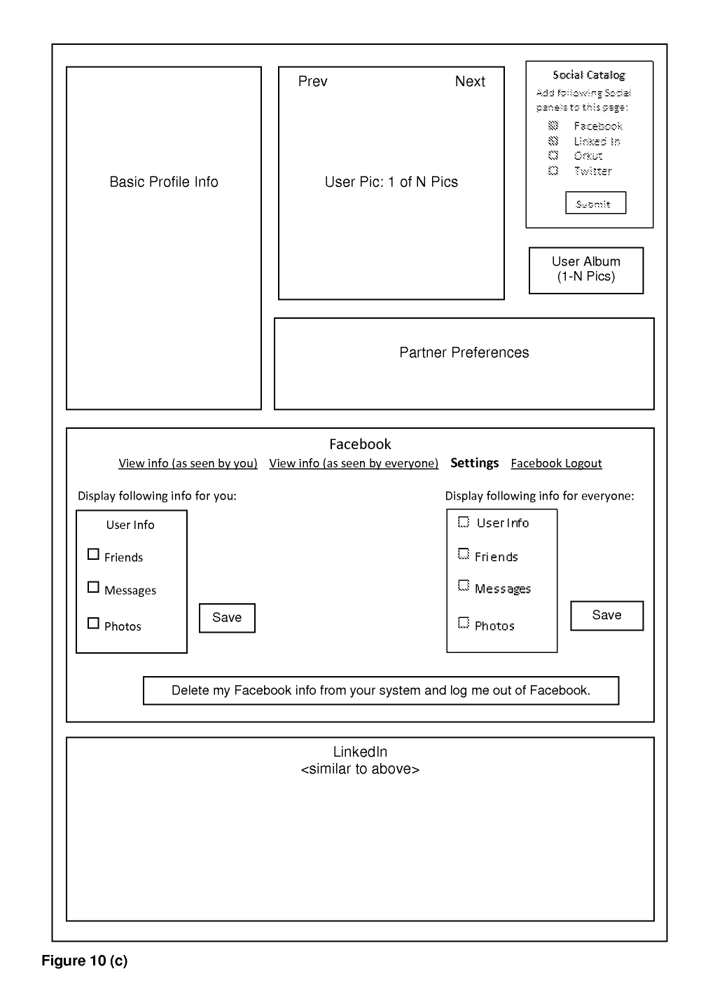

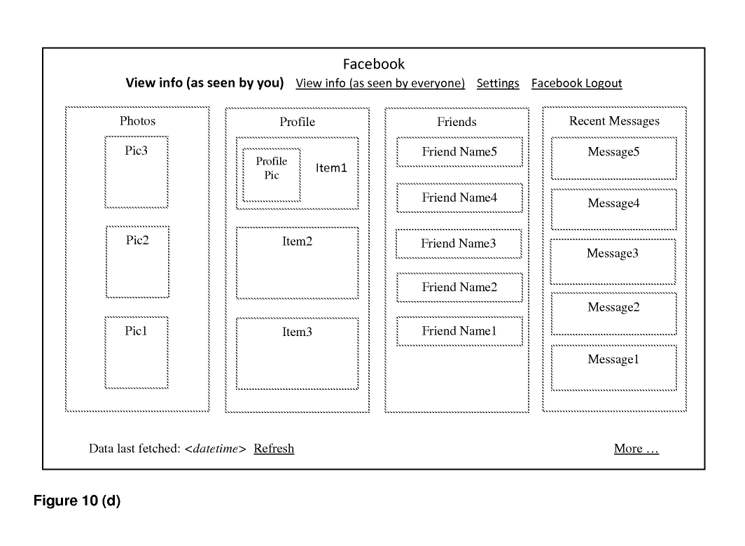

FIG. 10 (a) to FIG. 10 (d) shows the ‘View Profile’ system screens related to displaying data from social systems. The system screens explain a use case scenario.

Further, FIG. 10 (a) shows the ‘View Profile’ system screen that the Paid Active Profile (PAP) member sees after he/she logs into system and clicks on ‘View My Profile’ button. In FIG. 10 (b), the PAP member selects Facebook and LinkedIn panels in Social Catalog of ‘View Profile’ screen and submits his/her changes. Two panels containing login buttons would show up. The PAP member logs into Facebook and LinkedIn social systems by clicking the Login buttons present in Facebook and LinkedIn panels respectively in this system screen. During the first login to these social systems, the PAP member gives the system (i.e., MMBDC Portal system) the permission to access his/her social info on Face book and LinkedIn social systems. Further in FIG. 10 (c), the PAP member sets privacy settings on his/her social info in ‘Settings’ tab of social panel(s) on View Profile screen. Further in FIG. 10 (d), the PAP member sees his/her Facebook's social info in this ‘View info’ tab of Facebook social panel on View Profile screen. If in the ‘Settings’ tab, the PAP member has selected to show this same info to everyone, then any MMBDC Portal System end user browsing this PAP member profile screen can view this info. The PAP member also has an option to re-fetch his/her latest social data from Facebook server by clicking ‘Refresh’ link.

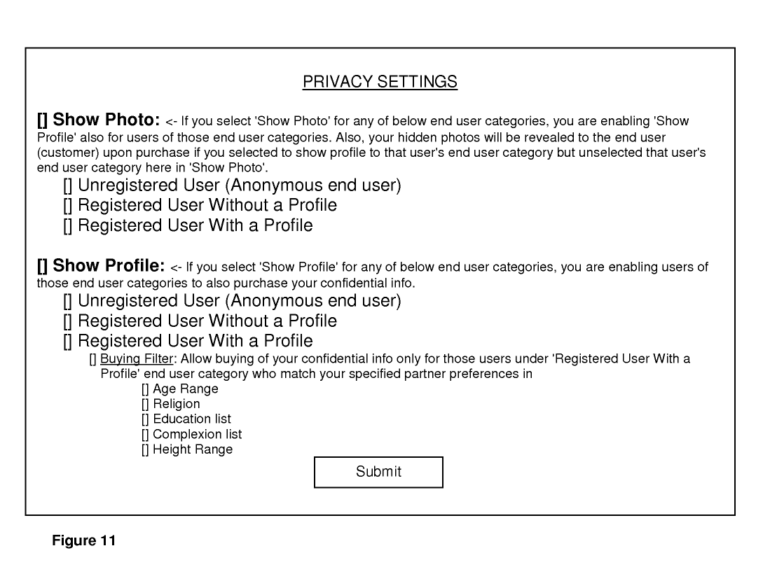

Further FIG. 11 shows the Privacy system screen where the PAP member sets his/her system-level privacy settings and buyer filters.

System Users Types:

The local or remote users who are browsing/navigating the MMBDC Portal System are called the MMBDC Portal System users. The system users types include but not limited to:
(i) End users (i.e., PAP members/system customers);
(ii) Business users (i.e., Participating MMBs);
(iii) Admin users (i.e., MMBDC Portal System Administrators/MMBDC Portal System Owners).

Participating Match Making Brokers Types:

Preferably, the Participating Match Making Brokers Types include, but not limited to:
(i) Match Making brokers (registered as well as unregistered) that don't have internet website.
   These include, but not limited to brokers who use papers and binders to store PAPs as well as those who use electronic format to store data. In later case, they may use local computers to store PAPs data and display them using standalone/intranet/extranet match making systems.
(ii) Match Making brokers (registered as well as unregistered) that have internet website.
   These include, but not limited to brokers who display PAPs data on internet as well as those who also allow online purchase of their PAPs data on their internet sites.
(iii) Internet-based relationship brokerage websites that get revenue mostly through memberships of internet users and through internet ads. They may/may not have customer facing physical offices to enroll people to membership. Categories of such internet-based social networking brokerage websites include, but not limited to the following:
   (i) Singles websites;
   (ii) Dating websites;
   (iii) Relationship websites;
   (iv) Matrimonial websites, etc.,
(iv) Newspapers/Magazines/Other Print Media that advertise PAPs.
(v) Match Making brokers that advertise PAPs through RSS feed/Ajax feed/Web service feed/XML feed/Other Electronic Media on internet.
(vi) Match Making brokers that have a ‘Portal Website’ which stores and/or collaborates and displays Paid Active Profiles (PAPs) from various sources/websites;
(vii) Match Making brokers who use match making systems/applications that run on mobile devices such as smart phones, tablets, laptops, hand-held devices, etc.,
(viii) Match Making brokers who use match making systems/applications that run on interactive home devices such as smart televisions, setup boxes, blu-ray devices, play stations, interactive entertainment devices, interactive audio/video devices, etc.

MMBs Data Consolidation/Collaboration Mechanism:

In this mechanism/business process, the PAPs data of the participating MMBs can be copied from individual MMB systems' data stores onto the MMBDC Portal System data store or they can be streamed directly from individual MMB systems' data stores, say through web services, and displayed on the MMBDC Portal System. The participating MMBs shall get prior approval from their members to publish their members' PAPs on the MMBDC Portal System. The participating MMBs can optionally charge a fee from their members to publish their PAPs on the MMBDC Portal System. For members who agreed to let the MMB publish their profile on the MMBDC Portal System, the MMB can optionally provide them with ‘MMB Member Restricted Membership’ (discussed later) on the MMBDC Portal System. The participating MMBs can sell the confidential information of their PAPs to one or more end users of MMBDC Portal System.

PAPs Data Ownership:

The participating MMBs are the owners of the PAPs data provided to the MMBDC Portal System and they remain the owners of their PAPs data throughout the ‘MMBDC Profile Data Life-cycle’ process. The participating MMBs own the responsibility of verifying and updating the ‘seeking status’ and Confidential Information of their PAPs posted on MMBDC Portal System. They are also responsible for verifying and updating other important public information of their PAPs posted on MMBDC Portal System. They should always do this verification whenever changes are done to these data either by the members or by their referrals or by the MMB itself or by the MMBDC Portal System administrator.

‘Non Paid Members’ Purchasing Options:

Purchasing options provided to a end user desiring to purchase PAPs on MMBDC Portal System without getting into paid membership include, but not limited to the following options:
(i) Per-profile ‘confidential information’ purchase option (or PPCI purchase option);
(ii) Bulk profiles ‘confidential information’ purchase option (or BPCI purchase option).

‘Incorrect Data’ Scenario:

In case the MMBDC Portal System end user has purchased the confidential information of a PAP that has incorrect confidential data or has its important public data specified incorrectly (such as its ‘seeking status’), then the choices provided to the MMBDC Portal System end user include, but not limited to the following options:
(i) No Purchase refund [Example: Claim is made after the refund period has expired];
(ii) Partial or Full Purchase refund;
(iii) Option to choose another PAP displayed on the MMBDC Portal System and obtain its confidential information at no extra cost.

PAPs Purchase Policy:

Some data of paid, active profile is dynamic and changes with time. This includes ‘seeking status’ and Confidential Information. So if a claim for refund of money is made by the system customer citing incorrect data, and if this data happen to be the dynamic data, then his/her claim will be honored only if it is filed within the specified period of days from the purchase date.

Duplicate PAPs Scenario:

In case, more than one participating MMB has uploaded/shared the same PAP on the MMBDC Portal System, all such profiles will be displayed without filtration to the MMBDC Portal System end users. The MMBDC Portal System end users can then purchase the confidential details from any of these duplicate profiles and the MMB of that chosen duplicate profile will be the beneficiary of the resulting transaction.

PAPs Pricing:

The participating MMBs can each price their uploaded, individual PAPs differently on the MMBDC Portal System with/without intervention by MMBDC Portal System owners. This includes duplicate PAPs. For system customers viewing duplicate PAPs with different prices on MMBDC Portal System, this pricing variation can be a deciding factor for selecting a specific MMB for making a purchase, thus making MMBDC Portal System an Auction Portal System for sellers in such a scenario.

Privacy Settings:

The MMBDC Portal System and Method allows PAP members to specify which of the following end user categories can view their profiles and photos as well as have the ability to purchase their confidential info. See FIG. 11 and FIG. 2 for related info.
(i) Unregistered User (Anonymous end user);
(ii) Registered User Without a Profile;
(iii) Registered User With a Profile.

On the MMBDC Portal System, if a PAP member selects to show his/her photos for any of above end user categories, he/she is enabling these end user categories users to also see his/her profile data barring confidential info [see FIG. 11].

In addition to the above, the PAP member's hidden photos will be revealed to end user upon purchase if the PAP member selected to show his/her profile to that user's end user category but unselected that user's end user category for showing his/her photos [see FIG. 11]. This covers the scenario where the buyer take risk to purchase the PAP member's confidential information based on PAP member's profile data and partner expectations but without seeing the PAP member's pictures. In this case, the hidden-photos are revealed to buyer after the purchase either through email or through unique photo unlock password that only works from his login session. These hidden-photos PAP members profiles can be kept the same sale price as other open photos PAP members profiles or can be priced low.

Also if the PAP member selects to show his/her profile data barring confidential info for any of above end user categories, he/she is also enabling them to also purchase his/her confidential info [see FIG. 11].

A buying filter can be set by PAP member to allow only ‘Registered User With a Profile’ category users who match the PAP member's partner preferences such as age range, religion, education list, complexion list, height range, etc., to purchase his/her confidential info [see FIG. 11].

Based on these settings, anonymous end users can purchase confidential info of PAPs on the MMBDC Portal System “without having to ‘register’/‘log’ into the system”. However Anonymous end users can only purchase confidential info of those PAP members who have agreed to show their profile to unregistered users and agreed to sell their confidential info to unregistered users.

Also the MMBDC Portal System allows end users to request a prospective PAP member to show his/her photo. The PAP member can either accept/deny this view photo request.

Free Membership Types:

The MMBDC Portal System and Method provides free membership schemes on MMBDC Portal System for MMBDC Portal System end users. See FIG. 2 and FIG. 3 for related info. The MMBDC free memberships include, but not limited to the following types:
(i) Registered Membership: This is a free, no cost membership that is available to all MMBDC Portal System end users. The MMBDC Portal System end users become registered members by filling a short system form on MMBDC Portal System. This form contains fields such as username, password, etc. The registered MMBDC Portal System end users upon login to MMBDC Portal System can access certain features of MMBDC Portal System that unregistered MMBDC Portal System end users can't access. Example is ‘Favorite Profiles’ listing where the registered MMBDC member, in his/her browsing session, can save prospective profiles for viewing/buying in his/her future browsing session(s);
(ii) MMB Member Restricted Membership: This membership is not available to all MMBDC Portal System end users. The participating MMBs can provide this membership either for free or for a fee to both their paid, active members whose profiles are uploaded/shared to the MMBDC Portal System as PAPs as well as to those whose profiles are not on the MMBDC Portal System. For the MMB members, this membership is only available for the duration of their MMB membership. The ‘MMB Member Restricted Membership’ is generally available for free to the MMB members whose profiles are published to the MMBDC Portal System since the MMB may have already collected a fee from them for publishing their profile on the MMBDC Portal System. The MMB would collect this fee from their members since the members automatically enjoy the benefits of a UPP membership (explained later) due to their profiles publication on the MMBDC Portal System. The ‘MMB Member Restricted Membership’ is generally available for a fee to the MMB's paid, active members whose profiles are not published to the MMBDC Portal System. With the ‘MMB Member Restricted Membership’, the members enjoy not only all the system features provided to registered members of MMBDC Portal System end users (such as ‘Favorite Profiles’ listing, etc.), they can also at no cost, view the confidential information of prospective PAPs of only their participating MMB. The number of prospective PAPs that they can see will be decided by their MMB.

Paid Membership Types:

The MMBDC Portal System and Method provide paid membership schemes on MMBDC Portal System for MMBDC Portal System end users. See FIG. 2 and FIG. 3 for related info. The MMBDC paid memberships include, but not limited to the following types:
(i) Uploaded n Paid Profiles Membership (or UPP Membership): The MMBDC Portal System end users can become UPP members by uploading their profiles to the MMBDC Portal System for free and then paying a fee for listing them alongside other PAPs on the MMBDC Portal System for a specific period of time. The MMBDC Portal System end users can only upload their profiles for free. But they would not be listed alongside other PAPs on the MMBDC Portal System. The minimum fee for listing the profile alongside other PAPs on MMBDC Portal System will be the minimum cost to purchase a PAP's confidential information on MMBDC Portal System. With this paid membership, the members benefit from being viewed and contacted by 1 or more prospective romantic partners browsing the MMBDC PAPs list. So without incurring any further cost than this paid membership cost, these members can be contacted by prospective romantic partners who are interested in their profile and have purchased their confidential information. They also enjoy all the system features provided to registered members of MMBDC Portal System end users (such as ‘Favorite Profiles’ listing, etc.). They will also have the ability to view on MMBDC Portal System screen (instead of through email or other communication means), the confidential information of specific number of PAPs revealed for free for promotional purposes. This promotion functionality of MMBDC Portal System screen is explained later. The UPP Membership expires after a set period of time or after a set period of inactivity of UPP member on the MMBDC Portal System.
(ii) Membership in Participating MMBs' Advertised Membership Schemes: The Participating MMBs can advertise their paid membership schemes on MMBDC Portal System stating that they will provide match making brokerage service to MMBDC Portal System's local and remote end users/customers for a specific period of time on MMBDC Portal System. The MMBDC Portal System end users can enroll in one or more of these membership schemes by paying the membership fee(s). These schemes allow members to access at no extra cost the confidential information of only their subscribed MMB's prospective PAPs present in MMBDC Portal System data store. The members can access some or all of PAPs confidential information of their subscribed MMB at no extra cost for the duration of the paid membership. The duration of the paid membership and the number of prospective PAPs confidential information that the member can see will be decided by the member's MMB and/or MMBDC Portal System owner(s). If the member needs to view the confidential information of another MMB's PAP or of any other PAP on the MMBDC Portal System for which his/her membership does not apply, he/she has to use Per-Profile Confidential Information (PPCI) purchase option. Also these advertised memberships require the member to upload his/her profile for free for listing alongside other PAPs on the MMBDC Portal System. These advertised memberships may also require the members to allow their subscribed MMBs to copy their uploaded profiles from the MMBDC Portal System into their individual MMB data stores. The subscribed MMBs can use these copied members' profiles at their offices or in their match making systems for match making purposes. The MMBDC Portal System members that are enrolled in one or more of the advertised MMBs' memberships enjoy not only the benefits of the subscribed MMBs' specific Membership scheme(s) but they also enjoy all the benefits of ‘Uploaded n Paid Profiles Membership’ at no extra cost. It can be observed that these membership schemes members have same or similar access to features and screens of MMBDC Portal System as the ‘MMB Member Restricted Membership’ members.

PAPs Types: The types of PAPs on MMBDC Portal System and Method include, but not limited to:
(i) PAPs of participating MMBs;
(ii) Profiles of ‘Uploaded n Paid Profiles Membership’ Members;
(iii) Profiles of “Participating MMBs' Advertised Membership Schemes” Members.

See FIG. 7 to view these PAP types on MMBDC Portal System.

Shared Events System Calendar:

The MMBDC Portal System and Method include a Shared Events System Calendar. See FIG. 8 for related info. The Participating MMBs can publish the details of their match making events on the Shared Events System Calendar and request their members browsing the MMBDC Portal System and optionally non-members (i.e., other MMBDC Portal System end users) to participate in these events. The MMBs can optionally charge an entry fee for non-members to attend their events. The MMBDC Portal System end user can see list of all events of all MMBs on this calendar and can then decide whether to attend one or more of them. Thus the Shared Events System Calendar has the potential to create competition between MMBs to create more and better events.

Free Viewing of PAPs Confidential Information:

The MMBDC Portal System and Method include a ‘portal system promotion’ functionality that reveals for every specific period, the confidential information of specific number of PAPs for free for registered members of MMBDC Portal System. See FIG. 9 for related info. These PAPs will be randomly picked from total data store of MMBDC Portal System (which includes but not limited to participating MMBs data stores, Uploaded n Paid Profiles data store, “Participating MMBs' Advertised Membership Schemes Enrolled Members Profiles” data stores). The randomization function of this ‘portal system promotion’ functionality will ensure that revealed PAPs will not be picked up again for revelation till specified time period and shown to registered MMBDC Portal System members. The communication means that will be used to reveal confidential information of these PAPs include but not limited to email, telephone (IVR call/SMS), postal mail, MMBDC Portal System, etc.

Upselling:

The MMBDC Portal System and Method includes upselling functionality for the MMBDC Portal System end user in the Per-Profile Confidential Information (PPCI) purchasing scenarios and Bulk Profiles Confidential Information (PPCI) purchasing scenarios to sell more PAPs or Memberships. The MMBDC Portal System also includes upselling functionality for the MMBDC Portal System end user in the “Participating MMBs' Advertised Membership Schemes” purchasing scenarios to sell more Memberships or PAPs.

‘Highly Purchasable Profiles Auto Listing’ Mechanism:

The MMBDC Portal System and Method include a ‘Highly Purchasable Profiles Auto Listing’ Mechanism/business process which identifies prospective PAPs that are most purchased till date and/or most recently purchased and lists them in the top so that the system end user/system customer will always see a rich listing of PAPs on the MMBDC Portal System. Also this process involves scrutinizing and filtering of PAPs of Participating MMBs by MMBDC Portal System owner(s) for salability and other factors before being uploaded/shared on the MMBDC Portal System. This scrutiny will be done even though the Participating MMBs would most likely upload/share their most sellable PAPs to the MMBDC Portal System to make most money in return for their time spent to publish these profiles. Thus, the MMBDC Portal System stands a chance to have a majority of its PAPs as most sellable profiles.

‘Profiles Auto Archiving’ Mechanism:

The MMBDC Portal System and Method include a ‘Profiles Auto Archiving’ Mechanism/business process. This monitors the membership status of all PAPs on the MMBDC Portal System and ensures that only the ‘Paid’ and ‘Active’ Profiles (PAPs) are displayed at all times on MMBDC Portal System. In other words, the PAPs of both the participating MMBs and the MMBDC Portal System which have their membership duration expired or have their ‘seeking status’ changed from ‘Active’ are denied from being displayed on MMBDC Portal System. This business process monitors the ‘paid-membership status’ and ‘seeking status’ of all profiles present in total data store of MMBDC Portal System. If a profile's ‘paid-membership status’ has changed from ‘Paid’ to ‘Expired’ (i.e., profile's paid-membership duration is over) or to some other status, it immediately removes that profile from display on the MMBDC Portal System. As a requirement of this ‘Profiles Auto Archiving’ process or say, monitoring-and-removal process, all PAPs of participating MMBs should include the profile's paid-membership ‘start date’ and paid-membership ‘end date’. In case of Uploaded n Paid Profiles (UPP) data store profiles, this monitoring-and-removal process looks at the membership ‘end date’ and also at the period of inactivity of UPP member on MMBDC Portal System. If the period of inactivity of UPP member is greater than set period of inactivity, that profile will be removed from display on the MMBDC Portal System. Similarly, in case of ‘Participating MMBs’ Advertised Membership Schemes Enrolled Members' profiles present in MMBDC Portal System data stores and also possibly in MMBs data stores, the monitoring-and-removal process looks at the membership ‘end date’ or ‘paid-membership status’ fields to make a determination for removal from display on MMBDC Portal System. The PAP can also be removed from display on MMBDC Portal System earlier than the profile's paid-membership ‘end date’ incase that profile member has found a romantic partner and/or no longer interested in MMBDC Portal System brokerage service. The participating MMBs or the MMBDC Portal System, through their customer facing physical/virtual offices can obtain this information earlier than the profile's paid-membership ‘end date’ and change the profile's ‘seeking status’ from ‘Active’ to another status. Also the profile member or his/her referral can update his/her profile's ‘seeking status’ from ‘Active’ online at the MMBDC Portal System or can inform the participating MMB/MMBDC Portal System at their customer interfacing physical/virtual office. When this happens, that PAP is removed from display on the MMBDC Portal System.

‘Profiles Auto Validation’ Mechanism:

The MMBDC Portal System and Method include a ‘Profiles Confidential Information Auto Validation’ Mechanism/business process which validates the confidential information and ‘seeking status’ of some random PAPs or all PAPs present in total data store of MMBDC Portal System. MMBDC Portal System need not contain all PAPs as Validated PAPs (VPAPs). The validation procedure includes, but not limited to following options:
(i) For PAP members contributed by MMBs:
   (a) IVR Survey—Make Interactive Voice Response (IVR) calls to contact phone number(s) specified in the PAP (PAP). If the answers provided to the IVR questions such as ‘Are you <the profile name> or referral of <the profile name> who is looking for Match making brokerage?’ and ‘Are you currently seeking a match?’ is ‘Yes’ and ‘Yes’ respectively, then that profile is considered a Validated PAP (VPAP).
   (b) Email Questionnaire—Send Email with questions to contact email(s) specified in the PAP (PAP). If the answers provided to the email questions such as ‘Are you <the profile name> or referral of <the profile name> who is looking for Match making brokerage?’ and ‘Are you currently seeking a match?’ is ‘Yes’ and ‘Yes’ respectively, then that profile is considered a Validated PAP (VPAP).
   To make the profile member or his/her referral to
   (a) answer the IVR questions without hanging up the phone, the IVR call can optionally specify in its introduction that upon completion of answers to all questions, a ‘promotional code’ will be revealed/told by the IVR.
   (b) answer the Email questions and email back the answers, the email questionnaire's first paragraph can optionally specify that upon submission of answers to questions, a ‘promotional code’ will be sent by email.
   The ‘promotional code’ allows the PAP member to log on to MMBDC Portal System and view the confidential information of a single, prospective PAP of his/her choice for free or at discounted price.
(ii) For new Uploaded n Paid Profiles (UPP) members:
   (a) Send ‘Authentication code’ through a) SMS/Voice Mails to contact phone number(s) b) email to contact email address(s) specified in the PAP (PAP).
      In this method, the PAP member is validated at the time of profile submission. The PAP member's profile is not accepted as fully submitted profile unless the authentication codes sent to phone and email are entered in profile verification stage of profile form.
   (b) Send ‘Promotion code’ through a) SMS/Voice Mails to contact phone number(s) b) email to contact email address(s) specified in the PAP (PAP).
      In this method, the PAP member is validated at the time of profile submission. The promotion code(s) allows the PAP member to log on to MMBDC Portal System and view the confidential information of a single, prospective PAP of his/her choice for free or at discounted price. If the profile member logs onto MMBDC Portal System and uses the promotion code(s) which were sent to phone and email, then that profile is considered a Validated PAP (VPAP).
   Optionally, on the ‘authentication code entry screen’/‘promotion code entry screen’ of MMBDC Portal System, the profile member can be asked questions such as ‘Are you <the profile name> or referral of <the profile name> who is looking for Match making brokerage?’ and ‘Are you currently seeking a match?’ to confirm his seeking status.

The MMBDC Portal System and Method uses above mentioned techniques and also 3rd party agencies to validate the profiles confidential information and provide the ‘Validated’ seal on profiles. The confidential information of these ‘validated’ sealed profiles are sold at higher price than those of non-validated profiles on MMBDC Portal System.

End User Credits Schemes/End User Coupons Schemes:

The MMBDC Portal System and Method include but not limited to the following credit schemes to make its members interested and visit the MMBDC Portal System. The eligible end users who obtained these credits can then use these credits to purchase Confidential Information of prospective PAPs at discounted rate on the MMBDC Portal System. They may/may not be told why they are getting credits.
(i) Scheme 1: The PAP members get a credit for having their profile Confidential Information purchased by other registered members of the MMBDC Portal System in their login sessions. If the number of purchases is more than the benchmarked value for the specified time period, the PAP member gets credit(s) after a specified period based on how highly his/her profile's confidential information is purchased.
(ii) Scheme 2: This scheme is valid for all registered members of MMBDC Portal System. The registered members get a credit for purchasing PAP members' profile Confidential Information on the MMBDC Portal System in their login sessions. If the number of purchases is more than the benchmarked value for the specified time period, the registered member gets credit(s) after a specified period based on how highly he/she has purchased. Even though Anonymous End users (i.e., non-registered members) of MMBDC Portal System can also purchase PAP members' profile Confidential Information on the MMBDC Portal System, they were not eligible for this or other credit schemes.
(iii) Scheme 3: The PAP members get a credit for having their profile viewed by other registered members of the MMBDC Portal System in their login sessions. If the number of views is more than the benchmarked value for the specified time period, the PAP member gets credit(s) after a specified period based on how highly his/her profile is viewed.
(iv) Scheme 4: In this scheme, the new end users of the MMBDC Portal System get a credit after a specified period for joining the MMBDC Portal System as a PAP member within specified period from credit-offer delivery date. This credit offer is sent to potential new end users through various delivery mechanisms such as email, SMS, postal mail, etc. This offer is intended to entice potential new end users to join MMBDC Portal System as PAP members. Note that in case of new UPP members, they still have to pay for uploading their profile and they can only use the credits of this scheme for purchasing other PAP members' profile confidential information.
(v) Scheme 5: In this scheme, the previous PAP members of MMBDC Portal System get a credit after a specified period for rejoining MMBDC Portal System as PAP member within specified period from credit-offer delivery date. This credit offer is sent to potential previous PAP members through various delivery mechanisms such as email, SMS, postal mail, etc. This offer is intended to entice potential previous PAP members to rejoin MMBDC Portal System as PAP members.

In each of above schemes, the credits gained by registered members/PAP members are converted to “one-time use” discount coupons/free purchase coupons and dispersed to them through various delivery mechanisms such as email/SMSs/MMBDC Portal System/postal mail/etc. These coupons are valid only for specified period and expire after this period.

Header Banner:

The MMBDC Portal System includes a header banner (with static/dynamic content) on home screen and other screens, stating “No membership required”, “Purchase profile contact info at only $x.xx per profile for most profiles”, “Thousands of verified profiles”, etc.

Social Systems Integration/Collaboration:

The MMBDC Portal System and Method includes integration and collaboration with the participating social systems and participating match making systems to display more ‘profile data’ and ‘social data’ about PAP members to system end users/system customers of the MMBDC Portal System. See FIG. 10 (a) to FIG. 10 (d) for related info.

This additional information is provided to MMBDC Portal System by PAP member though his/her explicit consent to MMBDC Portal System to fetch his/her ‘profile data’ and ‘social data’ from the social system/match making system and to display on MMBDC Portal System.

This additional profile data and social data is pulled for only these consenting PAP members from their existing profile(s) in various participating social systems/match making systems and displayed to system end users/system customers of the MMBDC Portal System.

Interactive Two-way Collaboration: The MMBDC Portal System and Method also includes collaboration with the participating social systems and participating match making systems to provide collaboration features and two-way communication features (i.e., from MMBDC Portal System to the participating social systems/participating match making systems and vice-versa) which include but not limited to
(i) allowing the PAP member who logged on MMBDC Portal system to add/modify/delete portions of his/her profile data and/or social data existing on participating social system(s)/participating match making system(s) using interfaces of MMBDC Portal System specific to those site(s). Examples include updating user status on participating social system, sending message to a friend on social system, etc., using MMBDC Portal System.
   This collaboration functionality is provided to the PAP member by MMBDC Portal System after the PAP member consents to MMBDC Portal System to allow him/her such collaboration with the social system(s)/match making system(s) from within the MMBDC Portal System.
(ii) allowing the PAP member who logged on participating social system(s)/participating match making system(s) to add/modify/delete portions of his/her PAP data existing on MMBDC Portal System using interfaces of those social system(s)/match making system(s). Examples include updating user's partner preferences on MMBDC Portal System, sending message to a potential partner on MMBDC Portal System, etc., using participating match making system.
   This collaboration functionality is provided to the PAP member by participating social system(s)/participating match making system(s) after the PAP member consents to those site(s) to allow him/her such collaboration with the MMBDC Portal System from within those site(s).

A brief specification of social systems integration is provided towards end of this ‘Detailed Description of the Invention’ section.

Bulk Purchases Discount Schemes:

The MMBDC Portal System and Method includes discount schemes for bulk profiles' confidential info purchase scenarios and bulk memberships purchase scenarios to generate buying interest in system customers. In case of “Bulk Profiles Confidential Information (BPCI)” purchasing scenarios, schemes like reduced profile confidential info purchase price for bulk purchases (e.g. ‘purchase confidential info of 5 profiles at price of 4 profiles’, ‘purchase 3 profiles confidential info and get the 4th profile confidential info absolutely free’, ‘buy 1 more at 20% less than its quoted price’, buy 3 more at 25% less than its quoted price', etc.) can generate buying interest in system customers. In case of “Participating MMBs' Advertised Membership Schemes” membership purchasing scenario, bulk purchases discount schemes like reduced membership price for bulk purchases (e.g. ‘purchase 5 MMB memberships at the price of 4 memberships’, ‘purchase 3 MMB memberships and get the 4th MMB membership absolutely free’, ‘buy 1 more MMB membership at 20% less than its quoted price’, buy 3 more MMB memberships at 25% less than its quoted price', etc.) can generate membership buying interest in system customers. Note that the profile confidential info purchase price can be different for different profiles. Also, the membership purchase price can be different for different “Participating MMBs' Advertised Membership Schemes”. So the above bulk purchases discounts will be discreetly given taken this variable pricing into consideration.

Participating MMB Identification:

The MMBDC Portal System and Method allow Participating MMB to hide, change or reveal its identity for system end users/system customers accessing the MMBDC Portal System. Some MMBs wish to hide or change their identity fearing that their customer base can shrink due to overt participation in the MMBDC Portal System. For these MMBs who wish to hide their identity, the MMB identity is shown as ‘anonymous’ when showing their PAPs or advertised paid membership scheme(s) on MMBDC Portal System. For those MMBs who wish to display a identity different from their true identity, the changed MMB identity is shown when showing their PAPs or advertised paid membership scheme(s) on MMBDC Portal System. For all other MMBs, their true identity is shown when showing their PAPs or advertised paid membership scheme(s) on MMBDC Portal System.

Here is an explanation on PAPs source identification:
(i) The participating MMBs can optionally associate their name to their PAPs in the MMBDC Portal System. The benefit with this is, the end users can see the MMB name as source of the profile and if they find a lot of prospective profiles from a particular MMB, they can plan on directly subscribing with that MMB using advertised paid membership scheme(s) that provide access to all profiles of MMB for a specific period of time instead of using per-profile purchasing in MMBDC Portal System which is expensive. If the participating MMB chooses not to associate its name as source of its profiles, then the source of these profiles will be displayed as ‘Anonymous’.
(ii) Some participating MMBs might fear that their existing members may opt out of their paid membership schemes (example: monthly/yearly subscription schemes) on their systems and migrate to MMBDC Portal System if they see that they can purchase the same profiles individually from their MMB at MMBDC Portal System using per-profile purchasing option at a cheaper overall price. In such a case, these MMBs can choose to keep their name blank (i.e., anonymous) or keep a different, fake name in profile source field, so that new/existing users/local customers of MMB will continue to subscribe to them in their systems as well as purchase their PAPs/advertised paid membership scheme(s) on the MMBDC Portal System with the hope of finding newer and better profiles.

Extensibility of ‘MMBDC Portal System and Method’ to Other Business Domains:

Information Selling Brokers Data Consolidation:

The MMBs Data Consolidation/Collaboration Portal System and Method can be extended from ‘MMBs’ business area to other business areas/service industries that have Information Selling Brokers (ISBs).

To apply the MMBDC Portal System and Method to other business areas, it can be generalized as follows:

A System and Method to collaborate and/or consolidate and display salable data items information (including optionally value-added data related to these data items from 3rd party connected systems) but barring the saleable confidential information of these data items, of one of more Participating Information Selling Brokers to system end users/system customers soliciting data items brokerage service who can then view one of more prospective saleable data items information on the system and optionally purchase their confidential information without having to mandatorily enroll in a paid membership that provides data items brokerage service for a specific period of time (example: 1 month membership, 3 months membership, etc.)

Yet further, the system and method can be generalized as follows:

A System and Method to collaborate and/or consolidate and display salable data items of numerous Information Selling Brokers and provide system customers seeking confidential information of these data item(s) with a per-data item ‘confidential information’ purchase option.

When extended to other business areas, the MMBDC Portal System and Method can be viewed as a single, mega Broker Data Consolidation System and Method (BDC System and Method) that collaborates and/or consolidates and displays data items of all information brokers of all business areas. It could also exist as individual systems dedicated to each business area.

Types of information selling brokers who currently do not have this MMBDC Portal System and Method and who can be brought under this system and method include, but not limited to
(i) Rental brokers;
(ii) Employment brokers;
(iii) Advisory brokers in various knowledge areas/business domains;
(iv) List brokers;
(v) Real estate brokers;
(vi) Investment brokers;
(vii) Sponsorship brokers;
(viii) Business brokers;
(ix) Joint venture brokers.

All the core work flows and functionality described in the MMBDC Portal System and Method are applicable without modification to these Information Selling Brokers (ISBs) of different business areas and they can be included in the Broker Data Consolidation System and Method (BDC System and Method). The required modifications if any are explained for each business area below.

Rental Brokers Data Consolidation:

In case of ‘Rental Brokers’ business area, the discrete information sets of “accommodation details-and-owner contact details” and “accommodation requirements-and-renter contact details” form the data items that the rental brokers would share on Broker Data Consolidation System (BDC System). These details may also be individually uploaded/posted by accommodation owners and accommodation seekers (renters) on the BDC System. The “owner contact details” and “renter contact details” are respectively the confidential information for the two data item types—“accommodation details-and-owner contact details” and “accommodation requirements-and-renter contact details”. The confidential information of these data items are sold on the BDC System to the accommodation seekers and accommodation providers using a per-data item ‘confidential information’ purchase option.

Employment Brokers Data Consolidation:

In case of ‘Employment Brokers’ business area, the discrete information sets of “employee details-and-employee contact details” and “employer requirements-and-employer contact details” form the data items that the employment brokers would share on Broker Data Consolidation System (BDC System). These details may also be individually uploaded/posted by employees and employers on the BDC System. The “employee contact details” are the confidential information for the corresponding “employer requirements-and-employer contact details” data items and these are sold on the BDC System to the employers using a per-data item ‘confidential information’ purchase option. The pricing for per-data item CI purchase will be less and competitive and there will be no fee charged again if the employer has taken the employee on board.

Advisory Brokers Data Consolidation:

In case of ‘Advisory Brokers’ business area, the information sets of “question”, “answer” and “question-and-answer” form the data items that the advisory brokers would share on Broker Data Consolidation System (BDC System). The “question” and “answer” data items may also be individually uploaded/posted by questioners and Subject Matter Experts (SMEs) respectively on the BDC System. The individual questioners who are registered on the BDC System can post questions for free on the BDC system if those questions not already present on the BDC system. However they have to pay a fee to view the SMEs-posted-answers for their questions or for existing answered questions on BDC system. For unanswered questions present on the BDC system, the individual SMEs who are registered on the BDC System and the SMEs associated with the advisory brokers will post the answers. The “answer” data items which are the confidential information for the corresponding “question” data items are sold on the BDC System to the questioners using a per-data item ‘confidential information’ purchase option.

List Brokers Data Consolidation:

In case of ‘List Brokers’ business area, the discrete information sets of “list details-and-list owner contact details” and “list requirements-and-list seeker contact details” form the data items that the list brokers would share on Broker Data Consolidation System (BDC System). These details may also be individually uploaded/posted by list owners and list seekers on the BDC System. The “list seeker contact details” are the confidential information for the corresponding “list requirements-and-list seeker contact details” data items and these are sold on the BDC System to the list owners using a per-data item ‘confidential information’ purchase option.

Real Estate Brokers Data Consolidation:

In case of ‘Real Estate Brokers’ business area, the discrete information sets of “property details-and-seller contact details” and “property requirements-and-buyer contact details” form the data items that the real estate brokers would share on Broker Data Consolidation System (BDC System). Property in this context means real estate property such as land, building, etc. These data item details may also be individually uploaded/posted by property owners (sellers) and property seekers (buyers) on the BDC System. The “buyer contact details” and optionally “seller contact details” are respectively the confidential information for the two data item types—“property requirements-and-buyer contact details” and “property details-and-seller contact details”. The confidential information of these data items are sold on the BDC System to the property owners and property seekers using a per-data item ‘confidential information’ purchase option. The pricing for per-data item CI purchase will be less and competitive and there will be no fee charged again if the buyer or seller has successfully completed the property deal.

Investment Brokers Data Consolidation:

In case of ‘Investment Brokers’ business area, the discrete information sets of “Investment details-and-seller contact details” and “Investment requirements-and-buyer contact details” form the data items that the investment brokers would share on Broker Data Consolidation System (BDC System). These details may also be individually uploaded/posted by investment sellers and investment buyers on the BDC System. The “seller contact details” and “buyer contact details” are respectively the confidential information for the two data item types—“Investment details-and-seller contact details” and “Investment requirements-and-buyer contact details”. The confidential information of these data items are sold on the BDC System to the investment sellers and investment buyers using a per-data item ‘confidential information’ purchase option. The pricing for per-data item CI purchase will be less and competitive and there will be no fee charged again if the buyer or seller has successfully completed the investment deal.

Sponsorship Brokers Data Consolidation:

In case of ‘Sponsorship Brokers’ business area, the discrete information sets of “sponsorship details-and-sponsor contact details” and “event/entity owners requirements-and-event/entity owners contact details” form the data items that the sponsorship brokers would share on Broker Data Consolidation System (BDC System). These details may also be individually uploaded/posted by sponsors and event/entity owners on the BDC System. The “event/entity owners contact details” are the confidential information for the corresponding “event/entity owners requirements-and-event/entity owners contact details” data items and these are sold on the BDC System to the sponsors using a per-data item ‘confidential information’ purchase option

Business Brokers Data Consolidation:

In case of ‘Business Brokers’ business area, the discrete information sets of “Business details-and-seller contact details” and “Business requirements-and-buyer contact details” form the data items that the business brokers would share on Broker Data Consolidation System (BDC System). These details may also be individually uploaded/posted by business sellers and business buyers on the BDC System. The “seller contact details” and “buyer contact details” are respectively the confidential information for the two data item types—“Business details-and-seller contact details” and “Business requirements-and-buyer contact details”. The confidential information of these data items are sold on the BDC System to the business sellers and business buyers using a per-data item ‘confidential information’ purchase option. The pricing for per-data item CI purchase will be less and competitive and there will be no fee charged again if the buyer or seller has successfully completed the business deal.

Joint Venture Brokers Data Consolidation:

In case of ‘Joint venture Brokers’ business area, the discrete information sets of “product/service details-and-product/service owner contact details” and “product/service requirements-and-product/service buyer/investor contact details” form the data items that the joint venture brokers would share on Broker Data Consolidation System (BDC System). These details may also be individually uploaded/posted by product/service sellers and product/service buyers/investors on the BDC System. The “product/service owner contact details” and “product/service buyer/investor contact details” are respectively the confidential information for the two data item types—“product/service details-and-product/service owner contact details” and “product/service requirements-and-product/service buyer/investor contact details”. The confidential information of these data items are sold on the BDC System to the product/service sellers and product/service buyers/investors using a per-data item ‘confidential information’ purchase option. The pricing for per-data item CI purchase will be less and competitive and there will be no fee charged again if the buyer or seller has successfully completed the purchase/investment deal.

Social Systems Integration/Collaboration Specification:

The MMBDC Portal System and Method include a functionality to retrieve PAP member's social info from his/her social system(s) & display it in MMBDC Portal System's ‘View Profile’ screen. This screen also displays PAP member's profile details from MMBDC Portal System's data store or MMB system's data store (3rd party data store). See FIG. 10 (a) to FIG. 10 (d) for related info.

This social info can include both the PAP member's public and private info on the social system(s). Note that the PAP member has the ability to set his/her profile info and social networking info as public or private in the privacy settings on the social system(s).

The MMBDC Portal System uses APIs/libraries of social system(s) to retrieve & display this social info of PAP member to system end users/system customers of the MMBDC Portal System. These APIs/libraries include but not limited to
(i) OpenSocial API for connection to Orkut and LinkedIn;
(ii) Twitterizer library or similar library for connection to Twitter;
(iii) Facebook Developer toolkit for connection to Facebook;
   The PAP member contains an option to show or hide his/her social info from being displayed on ‘View Profile’ screen in MMBDC Portal System.

Process Flow Summary:
(i) The PAP member sees his/her social info from a social system on profile screen when he/she logs into MMBDC Portal System. This is the private view of his/her profile screen.
(ii) The PAP member then has an option to make public/keep hidden (default) some/all of his/her social info for other system end users/system customers of the MMBDC Portal System to see.
(iii) Once the PAP member makes some/all of his/her social-networking public info public, other system end users/system customers of the MMBDC Portal System can view this PAP member's social info on profile screen when they navigate to his/her profile screen.

The MMBDC Portal System contains social info/data elements from social systems which include but not limited to:
(i) Facebook: The social info/data elements include but not limited to
   (a) Profile info (with profile picture)—also include bio, favorite quotations, family, relationships, status, etc.,
   (b) Friends list;
   (c) Photos;
   (d) Wall (i.e., wall ‘posts’ [public posts targeted to everyone] and ‘recent user activity’ list on wall);
      a) message post;
      b) Photos—photos uploaded by the user, tagged photos, albums, etc.,
      c) Video;
      d) event;
      e) link;
      f) recent user activity, etc.,
(ii) Twitter: The social info/data elements include but not limited to
   (a) profile info—username/screen name, person's name, profile image (default public), location, user's screen link, bio/description, email, etc.,
   (b) followers—number of followers, names of followers, thumbnails of followers, etc.,
   (c) following—number of people you are following, names of those people, thumbnails of people you are following, etc.,
   (d) tweets—i.e., tweets of user;
   (e) lists;
   (f) timelines;
   (g) private messages;
(iii) LinkedIn: The social info/data elements include but not limited to
   (a) profile info—member id, name, headline, location, industry, current status, summary, specialties, associations, honors, interests, pictureurl, etc.,
   (b) employment info—current position(s), past positions, their start dates and end dates, employer company names, etc.,
   (c) connections and recommendations info—number of connections, names of connections (i.e., individuals), number of recommenders, recommendations received, etc.,
(iv) Orkut: The social info/data elements include but not limited to
   (a) profile info—name, profile picture thumbnail url, status, album title, album pictures' thumbnail urls, profile updates, etc.,
   (b) network info—number of friends, names of friends, friends thumbnail url, scraps, recent visitors, etc.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

I claim:

1. A System to collaborate and/or consolidate and display Paid Active Profiles (PAPs) data (including optionally social data of PAP members from one or more social systems) but barring confidential information of PAPs, of one or more Participating Match Making Brokers (MMBs) to local and remote end users/customers soliciting match making brokerage service who can then view one or more prospective PAPs data and optionally purchase their confidential information without having to mandatorily enroll in a paid membership that provides match making brokerage service for a specific period of time (example: 1 month membership, 3 months membership, etc.), wherein the PAP data and social data of PAP members are displayed based on pre-defined privacy settings set by the PAP members.

2. The Paid Active Profile (PAP) members accessing the system of claim 1 can specify which of the following end user categories can view their profiles and photos as well as have the ability to purchase their confidential info.
a. Unregistered User (Anonymous end user)
b. Registered User Without a Profile
c. Registered User With a Profile

3. Based on the privacy settings set by PAP members, anonymous end users can purchase confidential info of PAPs in system of claim 1 “without having to ‘register’/‘log’ into the system”. However Anonymous end users can only purchase confidential info of those Paid Active Profile members who have agreed to show their profile to unregistered users and agreed to sell their confidential info to unregistered users.

4. Based on the privacy settings set by PAP members, a buying filter(s) can be set by PAP member in system of claim 1 to allow only ‘Registered User With a Profile’ category end users who match the PAP member's partner preferences such as age range, religion, education list, complexion list, height range, etc., to purchase his/her confidential info.

5. Based on the privacy settings set by PAP members, end users accessing the system of claim 1 can request a prospective PAP member to show his/her photo. The PAP member can either accept/deny this ‘view photo’ request. If the PAP member accepts this ‘view photo’ request, the hidden-photos are revealed to end user either through email or through unique photo unlock password that only works from his login session.

6. The local and remote end users/customers accessing the system of claim 1 can upload their profiles to the system for free and then pay a fee for listing them alongside other Paid Active Profiles on the system for a specific period of time.

7. The local and remote end users/customers accessing the system of claim 1 can pay and enroll in one or more of the advertised paid membership schemes of Participating Match Making Brokers (MMBs) that provide brokerage service for a specific period of time. These advertised paid membership schemes provide the local and remote end users/customers the benefit to view on the system, the confidential information of some or all of prospective Paid Active Profiles (PAPs) of only their subscribed match making broker(s) throughout their paid membership period at no extra cost.

8. The local and remote end users/customers accessing the system of claim 1 and participating in one or more of the advertised paid membership schemes of Participating Match Making Brokers (MMBs) that provide brokerage service for a specific period of time will require uploading their profile for free for listing their profile alongside other Paid Active Profiles on the system if and only if their profiles are not already present in the system data store or if their profiles are not active in the system data store.

9. If the local and remote end user/customer accessing the system of claim 1 happen to be already a paid, active member of the Participating Match Making Broker (MMB), he/she can upon approval of his/her MMB, at no cost or for a fee, for the duration of his/her MMB's membership, view the confidential information of some or all of prospective Paid Active Profiles (PAPs) of only his/her MMB listed on the system.

10. The local and remote end users/customers accessing the system of claim 1 will have the ability to save prospective Paid Active Profiles (PAPs) to their ‘Favorite Profiles’ listing once they are registered as users on the system. They can then access this listing and modify it in their next session(s)/visit(s) to the system.

11. The system of claim 1 contains a purchase refund policy to address the grievances of system customers complaining of inaccurate or changed dynamic data of their purchased profile. The dynamic data of the profile include but not limited to ‘seeking status’ and ‘Confidential Information’ of the profile. So if a customer of system of claim 1 has made a claim for refund of money citing incorrect or changed dynamic data of his/her purchased profile, then his/her claim will be honored only if it is filed within the specified period of days from the purchase date.

12. The system of claim 1 allows Participating Match Making Broker (MMB) to hide, change or reveal its identity for local and remote end users/customers accessing the system of claim 1. Some MMBs wish to hide or change their identity fearing that their customer base can shrink due to overt participation in system of claim 1. For these MMBs who wish to hide their identity, the MMB identity is shown as ‘anonymous’ when showing their PAPs or advertised paid membership scheme(s) on system of claim 1. For those MMBs who wish to display a identity different from their true identity, the changed MMB identity is shown when showing their PAPs or advertised paid membership scheme(s) on system of claim 1. For all other MMBs, their true identity is shown when showing their PAPs or advertised paid membership scheme(s) on system of claim 1.

13. The system of claim 1 allows duplicate Paid Active Profiles (PAPs). If more than one participating Match Making Broker has uploaded/shared the same Paid Active Profile on the system, then all such repeated Paid Active Profiles will be displayed without filtration on the system of claim 1.

14. The system of claim 1 allows participating Match Making Brokers (MMBs) to each price their uploaded, individual Paid Active Profiles (PAPs), including duplicate Paid Active Profiles (PAPs), differently on the system of claim 1 with/without intervention by the system owner(s). Thus the system of claim 1 acts as an Auction Portal System for sellers where the system customers can view Paid Active Profiles (PAPs), including duplicate Paid Active Profiles (PAPs) with different prices on system.

15. The Participating Match Making Brokers (MMBs) accessing the system of claim 1 can enter their match making events details into the Shared Events System Calendar of the system and can request their members and optionally non-members accessing the system to participate in these events either for fee or for free, thus creating a competition between MMBs to create more and better events.

16. The local and remote end users/customers accessing the system of claim 1 can see list of all events of all Participating Match Making Brokers (MMBs) on the Shared Events System Calendar of the system.

17. The system of claim 1 monitors the membership status of all Paid Active Profiles (PAPs) on the system and ensures that only the ‘paid’ and ‘active’ Profiles are displayed at all times on the system, or in other words those Paid Active Profiles (PAPs) of either the Participating Match Making Brokers (MMBs) or the system that have their paid membership duration expired or have their ‘seeking status’ changed from ‘Active’ are denied from being displayed on the system. This process thus provides auto-archival of Paid Active Profiles (PAPs) on the system of claim 1.

18. The system of claim 1 uses optional “upselling” in the Per-Profile Confidential Information (PPCI) purchasing scenarios, Bulk Profiles Confidential Information (PPCI) purchasing scenarios and Participating MMBs' Advertised Membership Schemes purchasing scenarios to sell more Paid Active Profiles and/or advertised memberships to the local and remote end users/customers of the system.

19. The system of claim 1 identifies Paid Active Profiles (PAPs) that are most purchased till date and/or most recently purchased and lists these Paid Active Profiles (PAPs) in top of the listing of Paid Active Profiles (PAPs) so that the local and remote end user/customer will always see a rich listing of Paid Active Profiles (PAPs) on the system of claim 1. This process thus provides auto-listing of highly purchasable Paid Active Profiles (PAPs) on the system of claim 1.

20. The Paid Active Profiles (PAPs) of Participating Match Making Brokers (MMBs) are scrutinized and filtered for salability and other factors by the owners of the system of claim 1 before being uploaded/shared on the system of claim 1. This scrutiny process will be done even though the Participating Match Making Brokers (MMBs) upload/share their most sellable Paid Active Profiles (PAPs) to the system of claim 1 with an intent to make most money in return for their time spent to upload/share these profiles. This process thus provides auto-listing of highly purchasable Paid Active Profiles (PAPs) on the system of claim 1.

21. The system of claim 1 includes a ‘portal system promotion’ functionality that reveals for free, for every specific period of time, the confidential information of specific number of randomly-chosen Paid Active Profiles picked from its total data store to registered members of system of claim 1. The randomization function will ensure that revealed Paid Active Profiles will not be picked up again till defined time period to show for free for registered members of system of claim 1. The communication means that will be used to reveal confidential information of these Paid Active Profiles include but not limited to email, telephone, postal mail, system of claim 1, etc.

22. The system of claim 1 validates the ‘confidential information’ and ‘seeking status’ of some random profiles or all profiles present in total data store of system of claim 1 (which includes but not limited to participating MMBs data stores, Uploaded n Paid Profiles data store, “Participating MMBs' Advertised Membership Schemes Enrolled Members Profiles” data stores) using techniques which include but not limited to Interactive Voice Response (IVR) Survey and Email Questionnaire for PAP members contributed by MMBs and sending of authentication codes, sending of promotion codes to new Uploaded n Paid Profiles (UPP) members during profile submission process. This process thus provides ‘Profiles Confidential Information Auto Validation’ Mechanism on the system of claim 1. The system of claim 1 uses above mentioned techniques and also 3rd party agencies to validate the profiles confidential information and provide the ‘Validated’ seal on profiles. The confidential information of these ‘validated’ sealed profiles are sold at higher price than those of non-validated profiles on system of claim 1.

23. The system of claim 1 includes integration with the social systems (which includes but not limited to LinkedIn, Facebook, Twitter, Orkut, etc.) and match making systems (which includes but not limited to Match.com, eHarmony, Bharatmatrimony.com, Shaadi.com, etc.) to display more ‘profile data’ and ‘social data’ about Paid Active Profile (PAP) members to local and remote end users/customers of the system of claim 1. This additional profile info and social info is pulled for only consenting Paid Active Profile (PAP) members from their existing profile(s) in various social systems/match making systems and displayed to local and remote end users/customers of the system of claim 1.

24. The system of claim 1 also includes collaboration with the participating social systems and participating match making systems to provide collaboration features and two-way communication features (i.e., from system of claim 1 to the participating social systems/participating match making systems and vice-versa) which include but not limited to
a. ability of the PAP member who logged on the system of claim 1 to add/modify/delete data elements of his/her profile data & social data existing on participating social system(s)/participating match making system(s) from within the system of claim 1 using interfaces of system of claim 1 specific to those social system(s)/match making system(s).
b. the ability of the PAP member who logged on the participating social system(s)/participating match making system(s) to add/modify/delete data elements of his/her PAP data existing on system of claim 1 using interfaces of those social system(s)/match making system(s).

25. The system of claim 1 contains a header promotional banner (with static/dynamic content) on home screen and other screens. This banner displays info on various ‘Paid Active Profiles (PAPs) Confidential Info’ purchasing schemes and Portal System features. They include, but not limited to the following: “No membership required”, “Purchase profile contact info at only $x.xx per profile for most profiles”, “Thousands of verified profiles”, “Dating revolution—purchase partner profiles based on partner preferences”, “post your profile info and get purchased by partners who match your partner preference”, etc.

26. The system of claim 1 contains End User Credits Schemes/End User Coupons Schemes to a) make its members contribute more/rich content to their profiles or to the system of claim 1 b) make its members purchase more often the Confidential Information of prospective Paid Active Profiles (PAPs) on the system of claim 1 c) make its old members interested and re-join in the system of claim 1 d) make non-members interested and join in the system of claim 1 e) make its members interested and retained on the system of claim 1. The eligible end users who obtained these credits/coupons can use them to purchase Confidential Information of prospective Paid Active Profiles (PAPs) at discounted rate or for free on the system of claim 1.

27. The system of claim 1 contains Bulk Purchases Discount Schemes for bulk profiles' confidential information purchase scenarios and bulk memberships purchase scenarios to make the customer of system of claim 1 purchase more Paid Active Profiles' Confidential Information and more memberships of “Participating MMBs' Advertised Membership Schemes” on the system of claim 1.

28. A Method to collaborate and/or consolidate and display Paid Active Profiles (PAPs) data (including optionally social data of PAP members from one or more social systems) but barring confidential information of PAPs, of one or more Participating Match Making Brokers (MMBs) to local and remote end users/customers (hereafter called as end users) soliciting match making brokerage service who can then view one or more prospective PAPs data and optionally purchase their confidential information without having to mandatorily enroll in a paid membership that provides match making brokerage service for a specific period of time (example: 1 month membership, 3 months membership, etc.), wherein the PAP data and social data of PAP members are displayed based on pre-defined privacy settings set by the PAP members.

29. The method of claim 28, can be implemented as an application means in all electronic communication devices which includes but not limited to smart phones, smart televisions, IPads, computers, laptops, desktops, tablets, telephone devices, etc. that use one of more of all communicating network mediums which includes but not limited to Internet, cellular networks, radio, Wi-Fi, blue tooth, cable networks, telephone network, a radio wave, an electric signal, a wave, etc. or in any other virtual environment.

30. The method of claim 28, can be implemented as a stand-alone application means or portable application means in all basic data storage means which includes not limited to USB stick, flash card, pen drive, CD, magnetic disk, mini-disk, magneto-optical disk, multimedia memory card, secure digital card, memory stick, or any other portable data storage means etc.

31. A Method to collaborate and/or consolidate and display salable data items information (including optionally value-added data related to these data items from 3rd party connected systems) but barring the saleable confidential information of these data items, of one of more Participating Information Selling Brokers to local and remote end users/customers soliciting data items brokerage service who can then view one of more prospective saleable data items information on the system and optionally purchase their confidential information without having to mandatorily enroll in a paid membership that provides data items brokerage service for a specific period of time (example: 1 month membership, 3 months membership, etc.)

32. The method of claim 31, can be implemented as an application means in business areas which currently don't have this method and where this method can be applied as-is without modification. These business areas include but not limited to the following: rental brokers; employment brokers; advisory brokers in various knowledge areas/business domains; list brokers; real estate brokers; investment brokers; sponsorship brokers; business brokers; joint venture brokers; etc.
